(19) United States
(12) Patent Application Publication
(10) Pub. No.: US 2026/0332751 A1
(43) Pub. Date: Oct. 22, 2026

(54) VIDEO SIGNAL PROCESSING METHOD USING GEOMETRIC DIVISION, AND DEVICE THEREFOR

(71) Applicant: WILUS INSTITUTE OF STANDARDS AND TECHNOLOGY INC., Gyeonggi-do (KR)

(72) Inventors: Kyungyong KIM, Gyeonggi-do (KR); Dongcheol KIM, Gyeonggi-do (KR); Juhyung SON, Gyeonggi-do (KR); Jinsam KWAK, Gyeonggi-do (KR)

(21) Appl. No.: 19/108,739

(22) PCT Filed: Sep. 5, 2023
(86) PCT No.: PCT/KR2023/013228

§ 371 Date: Mar. 5, 2025

(30) Foreign Application Priority Data
Sep. 6, 2022 (KR) 10-2022-0112569
Aug. 7, 2023 (KR) 10-2023-0102921

(51) Int. Cl. H04N 19/11; H04N 19/119; H04N 19/176

(52) U.S. Cl. CPC H04N 19/11; H04N 19/119; H04N 19/176

(57) ABSTRACT

A video signal decoding device is disclosed. The decoding device comprises a processor. The processor divides a current block into multiple areas according to a reference line, and performs prediction for each divided area. At least one of the multiple areas is predicted through intra prediction.

### TECHNICAL FIELD

The present disclosure relates to a video signal processing method and device and, more specifically, to a video signal processing method and device by which a video signal is encoded or decoded.

### BACKGROUND ART

Compression coding refers to a series of signal processing techniques for transmitting digitized information through a communication line or storing information in a form suitable for a storage medium. An object of compression encoding includes objects such as voice, video, and text, and in particular, a technique for performing compression encoding on an image is referred to as video compression. Compression coding for a video signal is performed by removing excess information in consideration of spatial correlation, temporal correlation, and stochastic correlation. However, with the recent development of various media and data transmission media, a more efficient video signal processing method and apparatus are required.

### DISCLOSURE OF INVENTION

### Technical Problem

An aspect of the present specification is to provide a video signal processing method and a device therefor to increase the coding efficiency of a video signal.

### Solution to Problem

A decoding device according to an embodiment of the disclosure includes a processor.

The processor divides a current block into multiple areas according to a reference line, and performs prediction for each divided area. In this case, at least one of the multiple areas is predicted through intra prediction.

The processor may generate candidates for each combination of the division shape and an intra prediction directional mode when generating a candidate list including candidates of intra prediction directional mode information used for prediction of at least one area predicted through the intra prediction.

The processor may exclude a candidate from the candidate list whose difference between the angle corresponding to the direction corresponding to the division shape and the angle indicated by the intra prediction directional mode is less than or equal to a pre-specified value.

The processor may exclude a candidate from the candidate list whose difference between the index of the intra prediction directional mode and the index of the intra prediction directional mode corresponding to the direction corresponding to the division shape is less than or equal to a

The processor may configure the angle corresponding to the direction corresponding to the division shape of a first candidate to the angle indicated by the intra prediction directional mode when the angle corresponding to the direction corresponding to the division shape of the first candidate in the candidate list is different from the angle indicated by the intra prediction directional mode of the first candidate.

The processor may specify the priority of the first candidate as a higher priority than the second candidate when the difference between the index of the intra prediction directional mode of the neighboring block adjacent to the current block and the index of the intra prediction directional mode used for the first candidate in the candidate list is within a pre-specified value, and the difference between the index of the intra prediction directional mode of the neighboring block adjacent to the current block and the index of the intra prediction directional mode used for the second candidate in the candidate list is equal to or greater than the pre-specified value.

The processor may determine a weight to be used when calculating the cost of the candidate based on the difference between the index of the intra prediction directional mode of the neighboring block adjacent to the current block and the index of the intra prediction directional mode used for the candidate in the candidate list.

The processor may recalculate a cost by multiplying the cost of the corresponding candidate calculated by SAD or MR-SAD by a weight greater than 1 when the difference between the index of the intra prediction directional mode of the adjacent neighboring block and the index of the intra prediction directional mode used for the candidate is greater than a pre-specified value.

A bitstream including the video signal may include syntax indicating whether either GPM mode or ISP mode is used for encoding. In this case, the processor may obtain the syntax from the bitstream and determine whether the current block is encoded in either GPM mode or ISP mode.

The processor may determine the strength of a deblocking filter used to reconstruct the current block, based on whether one of the multiple areas is encoded by using an intra prediction mode.

An encoding device for encoding a video signal according to an embodiment of the disclosure includes a processor. The processor divides a current block into multiple areas according to a reference line, and performs prediction for each divided area. In this case at least one of the multiple areas is predicted through intra prediction.

The processor may generate candidates for each combination of the division shape and an intra prediction directional mode when generating a candidate list including candidates of intra prediction directional mode information used for prediction of at least one area predicted through the intra prediction.

The processor may exclude a candidate from the candidate list whose difference between the angle corresponding to the direction corresponding to the division shape and the angle indicated by the intra prediction directional mode is less than or equal to a pre-specified value.

The processor may exclude a candidate from the candidate list whose difference between the index of the intra prediction directional mode and the index of the intra prediction directional mode corresponding to the direction corresponding to the division shape is less than or equal to a pre-specified value.

The processor may configure the angle corresponding to the direction corresponding to the division shape of a first candidate to the angle indicated by the intra prediction directional mode when the angle corresponding to the direction corresponding to the division shape of the first candidate in the candidate list is different from the angle indicated by the intra prediction directional mode of the first candidate.

The processor may specify the priority of the first candidate as a higher priority than the second candidate when the difference between the index of the intra prediction directional mode of the neighboring block adjacent to the current block and the index of the intra prediction directional mode used for the first candidate in the candidate list is within a pre-specified value, and the difference between the index of the intra prediction directional mode of the neighboring block adjacent to the current block and the index of the intra prediction directional mode used for the second candidate in the candidate list is equal to or greater than the pre-specified value.

The processor may determine a weight to be used when calculating the cost of the candidate based on the difference between the index of the intra prediction directional mode of the neighboring block adjacent to the current block and the index of the intra prediction directional mode used for the candidate in the candidate list.

The processor may recalculate a cost by multiplying the cost of the corresponding candidate calculated by SAD or MR-SAD by a weight greater than 1 when the difference between the index of the intra prediction directional mode of the adjacent neighboring block and the index of the intra prediction directional mode used for the candidate is greater than a pre-specified value.

The processor may include syntax indicating whether either GPM mode or ISP mode is used for encoding in a bit stream including the video signal.

The processor may determine the strength of a deblocking filter used to reconstruct the current block, based on whether one of the multiple areas is encoded by using an intra prediction mode.

In a computer-readable non-transitory storage medium storing a bitstream according to an embodiment of the disclosure, the bitstream is decoded by a decoding method. The decoding method includes dividing a current block into multiple areas according to a reference line; and
performing prediction for each divided area. In this case, at least one of the multiple areas is predicted through intra prediction.

### Advantageous Effects of Invention

The specification provides a method for efficiently processing a video signal. The effects that may be obtained from this specification are not limited to the effects mentioned above, and other effects that are not mentioned will be clearly understood by those skilled in the art to which the disclosure belongs from the description below.

### BRIEF DESCRIPTION OF DRAWINGS

FIG. 1 is a schematic block diagram of a video signal encoding apparatus according to an embodiment of the present invention.

FIG. 2 is a schematic block diagram of a video signal decoding apparatus according to an embodiment of the present invention.

FIG. 3 shows an embodiment in which a coding tree unit is divided into coding units in a picture.

FIG. 4 shows an embodiment of a method for signaling a division of a quad tree and a multi-type tree.

FIGS. 5 and 6 illustrate an intra-prediction method in more detail according to an embodiment of the present disclosure.

FIG. 7 illustrates the position of neighboring blocks used to construct a motion candidate list in inter prediction.

FIG. 8 illustrates a syntax for signaling by integrating the angle of a reference line and the distance of the reference line from the center position in the GPM mode, and specific information signaled by the syntax according to an embodiment of the disclosure.

FIG. 9 illustrates a reference line according to the value of the merge GPM partition index, and a syntax indicating information on the GPM mode in an embodiment of the disclosure.

FIG. 10 illustrates a method of deriving a GPM partition shape and an intra prediction mode, based on a template according to an embodiment of the disclosure.

FIG. 11 illustrates a method of deriving a GPM and an intra prediction directional mode, based on a template according to an embodiment of the disclosure.

FIG. 12 illustrates an angle of a partition reference line used in a GPM mode according to an embodiment of the disclosure.

FIG. 13 illustrates a syntax structure of a method for signaling by integrating a GPM mode and an ISP mode according to an embodiment of the disclosure.

FIG. 14 illustrates a partition shape of a GPM mode that divides a current block into two or more areas according to an embodiment of the disclosure.

FIG. 15 illustrates a partition shape of a current block to which a GPM mode is applied according to an embodiment of the disclosure.

FIG. 16 illustrates types of transform kernels that may be used for video coding according to an embodiment of the disclosure.

FIG. 17 illustrates a method of applying MTS and LFNST to an error signal of a current block to which a GPM mode is applied according to an embodiment of the disclosure.

FIG. 18 is a table illustrating a relationship between a value of the directional mode of the intra prediction mode corresponding to an area of the current block divided in a GPM mode and the index of an MTS set determined depending on the size of the current block according to an embodiment of the disclosure.

FIG. 19 is a table illustrating a relationship between values of nTrSet and mts_idx according to an embodiment of the disclosure.

FIG. 20 is a table illustrating a relationship between an index indicating a transform type and a kernel used for transformation according to an embodiment of the disclosure.

FIG. 21 is a table illustrating a relationship between the horizontal and vertical sizes of the current block and a pre-specified value that serves as a criterion for reconfiguring the transform type according to an embodiment of the disclosure.

FIG. 22 illustrates a method of performing intra prediction by determining a reference pixel line based on a template according to an embodiment of the disclosure.

FIG. 23 illustrates a method of performing prediction by using a block vector of a block encoded in an IBC mode according to an embodiment of the disclosure.

FIG. 24 illustrates an RRIBC being performed according to an embodiment of the disclosure.

FIG. 25 illustrates an RRIBC being performed according to an embodiment of the disclosure.

FIG. 26 illustrates an embodiment of a block vector of a block encoded in an intra TMP mode according to an embodiment of the disclosure.

FIG. 27 illustrates that a current block is divided into two areas in a GPM mode and the divided areas are encoded in an IBC mode according to an embodiment of the disclosure.

FIG. 28 illustrates that a current block is encoded in an IBC-CIIP mode according to an embodiment of the disclosure.

FIG. 29 illustrates an embodiment of a block boundary and samples around the block boundary in a deblocking filtering process according to an embodiment of the disclosure.

### MODE FOR CARRYING OUT THE INVENTION

Terms used in this specification may be currently widely used general terms in consideration of functions in the present invention but may vary according to the intents of those skilled in the art, customs, or the advent of new technology. Additionally, in certain cases, there may be terms the applicant selects arbitrarily and in this case, their meanings are described in a corresponding description part of the present invention. Accordingly, terms used in this specification should be interpreted based on the substantial meanings of the terms and contents over the whole specification.

In this specification, ‘A and/or B’ may be interpreted as meaning ‘including at least one of A or B.’

In this specification, some terms may be interpreted as follows. Coding may be interpreted as encoding or decoding in some cases. In the present specification, an apparatus for generating a video signal bitstream by performing encoding (coding) of a video signal is referred to as an encoding apparatus or an encoder, and an apparatus that performs decoding (decoding) of a video signal bitstream to reconstruct a video signal is referred to as a decoding apparatus or decoder. In addition, in this specification, the video signal processing apparatus is used as a term of a concept including both an encoder and a decoder. Information is a term including all values, parameters, coefficients, elements, etc. In some cases, the meaning is interpreted differently, so the present invention is not limited thereto. ‘Unit’ is used as a meaning to refer to a basic unit of image processing or a specific position of a picture, and refers to an image region including both a luma component and a chroma component. Furthermore, a “block” refers to a region of an image that includes a particular component of a luma component and chroma components (i.e., Cb and Cr). However, depending on the embodiment, the terms “unit”, “block”, “partition”, “signal”, and “region” may be used interchangeably. Also, in the present specification, the term “current block” refers to a block that is currently scheduled to be encoded, and the term “reference block” refers to a block that has already been encoded or decoded and is used as a reference in a current block. In addition, the terms “luma”, “luminance”, “Y”, and the like may be used interchangeably in this specification. Additionally, in the present specification, the terms “chroma”, “chrominance”, “Cb or Cr”, and the like may be used interchangeably, and chroma components are classified into two components, Cb and Cr, and thus each chroma component may be distinguished and used. Additionally, in the present specification, the term “unit” may be used as a concept that includes a coding unit, a prediction unit, and a transform unit. A “picture” refers to a field or a frame, and depending on embodiments, the terms may be used interchangeably. Specifically, when a captured video is an interlaced video, a single frame may be separated into an odd (or cardinal or top) field and an even (or even-numbered or bottom) field, and each field may be configured in one picture unit and encoded or decoded. If the captured video is a progressive video, a single frame may be configured as a picture and encoded or decoded. In addition, in the present specification, the terms “error signal”, “residual signal”, “residue signal”, “remaining signal”, and “difference signal” may be used interchangeably. Also, in the present specification, the terms “intra-prediction mode”, “intra-prediction directional mode”, “intra-picture prediction mode”, and “intra-picture prediction directional mode” may be used interchangeably. In addition, in the present specification, the terms “motion”, “movement”, and the like may be used interchangeably. Also, in the present specification, the terms “left”, “left above”, “above”, “right above”, “right”, “right below”, “below”, and “left below” may be used interchangeably with “leftmost”, “top left”, “top”, “top right”, “right”, “bottom right”, “bottom”, and “bottom left”. Also, the terms “element” and “member” may be used interchangeably. Picture order count (POC) represents temporal position information of pictures (or frames), and may be the playback order in which displaying is performed on a screen, and each picture may have unique POC.

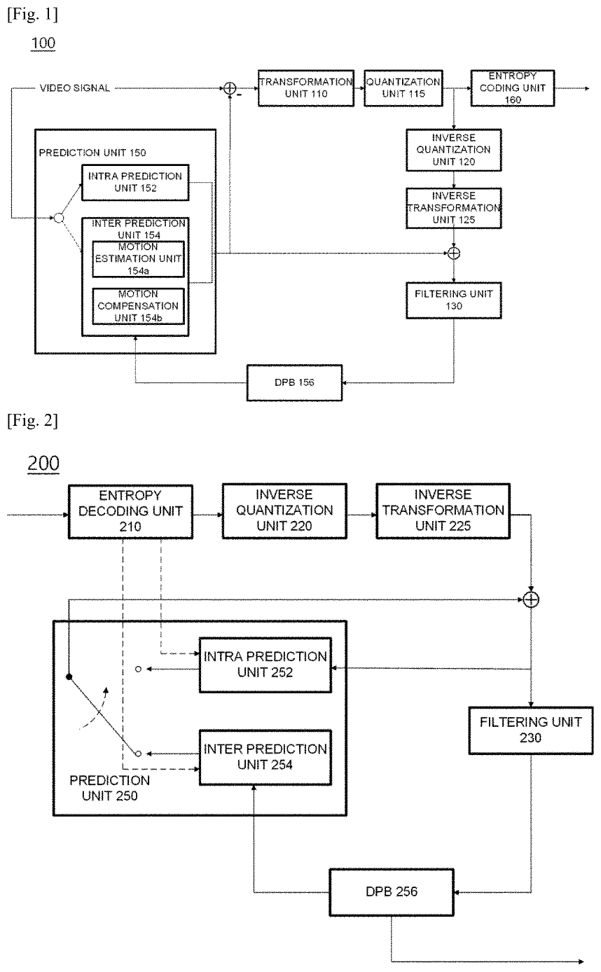

FIG. 1 is a schematic block diagram of a video signal encoding apparatus according to an embodiment of the present invention. Referring to FIG. 1, the encoding apparatus 100 of the present invention includes a transformation unit 110, a quantization unit 115, an inverse quantization unit 120, an inverse transformation unit 125, a filtering unit 130, a prediction unit 150, and an entropy coding unit 160.

The transformation unit 110 obtains a value of a transform coefficient by transforming a residual signal, which is a difference between the inputted video signal and the predicted signal generated by the prediction unit 150. For example, a Discrete Cosine Transform (DCT), a Discrete Sine Transform (DST), or a Wavelet Transform can be used. The DCT and DST perform transformation by splitting the input picture signal into blocks. In the transformation, coding efficiency may vary according to the distribution and characteristics of values in the transformation region. A transform kernel used for the transform of a residual block may has characteristics that allow a vertical transform and a horizontal transform to be separable. In this case, the transform of the residual block may be performed separately as a vertical transform and a horizontal transform. For example, an encoder may perform a vertical transform by applying a transform kernel in the vertical direction of a residual block. In addition, the encoder may perform a horizontal transform by applying the transform kernel in the horizontal direction of the residual block. In the present disclosure, the transform kernel may be used to refer to a set of parameters used for the transform of a residual signal, such as a transform matrix, a transform array, a transform function, or transform. For example, a transform kernel may be any one of multiple available kernels. Also, transform kernels based on different transform types may be used for the vertical transform and the horizontal transform, respectively.

The transform coefficients are distributed with higher coefficients toward the top left of a block and coefficients closer to “0” toward the bottom right of the block. As the size of a current block increases, there are likely to be many coefficients of “0” in the bottom-right region of the block. To reduce the transform complexity of a large-sized block, only a random top-left region may be kept and the remaining region may be reset to “0”.

In addition, error signals may be present in only some regions of a coding block. In this case, the transform process may be performed on only some random regions. In an embodiment, in a block having a size of 2N×2N, an error signal may be present only in the first 2N×N block, and the transform process may be performed on the first 2N×N block. However, the second 2N×N block may not be transformed and may not be encoded or decoded. Here, N may be any positive integer.

The encoder may perform an additional transform before transform coefficients are quantized. The above-described transform method may be referred to as a primary transform, and the additional transform may be referred to as a secondary transform. The secondary transform may be selective for each residual block. According to an embodiment, the encoder may improve coding efficiency by performing a secondary transform for regions where it is difficult to focus energy in a low-frequency region by using a primary transform alone. For example, a secondary transform may be additionally performed for blocks where residual values appear large in directions other than the horizontal or vertical direction of a residual block. Unlike a primary transform, a secondary transform may not be performed separately as a vertical transform and a horizontal transform. Such a secondary transform may be referred to as a low frequency non-separable transform (LFNST).

The quantization unit 115 quantizes the value of the transform coefficient value outputted from the transformation unit 110.

In order to improve coding efficiency, instead of coding the picture signal as it is, a method of predicting a picture using a region already coded through the prediction unit 150 and obtaining a reconstructed picture by adding a residual value between the original picture and the predicted picture to the predicted picture is used. In order to prevent mismatches in the encoder and decoder, information that can be used in the decoder should be used when performing prediction in the encoder. For this, the encoder performs a process of reconstructing the encoded current block again. The inverse quantization unit 120 inverse-quantizes the value of the transform coefficient, and the inverse transformation unit 125 reconstructs the residual value using the inverse quantized transform coefficient value. Meanwhile, the filtering unit 130 performs filtering operations to improve the quality of the reconstructed picture and to improve the coding efficiency. For example, a deblocking filter, a sample adaptive offset (SAO), and an adaptive loop filter may be included. The filtered picture is outputted or stored in a decoded picture buffer (DPB) 156 for use as a reference picture.

The deblocking filter is a filter for removing intra-block distortions generated at the boundaries between blocks in a reconstructed picture. Through the distribution of pixels included in several columns or rows based on random edges in a block, the encoder may determine whether to apply a deblocking filter to the edges. When applying a deblocking filter to the block, the encoder may apply a long filter, a strong filter, or a weak filter depending on the strength of deblocking filtering. Additionally, horizontal filtering and vertical filtering may be processed in parallel. The sample adaptive offset (SAO) may be used to correct offsets from an original video on a pixel-by-pixel basis with respect to a residual block to which a deblocking filter has been applied. To correct offset for a particular picture, the encoder may use a technique that divides pixels included in the picture into a predetermined number of regions, determines a region in which the offset correction is to be performed, and applies the offset to the region (Band Offset). Alternatively, the encoder may use a method for applying an offset in consideration of edge information of each pixel (Edge Offset). The adaptive loop filter (ALF) is a technique of dividing pixels included in a video into predetermined groups and then determining one filter to be applied to each group, thereby performing filtering differently for each group. Information about whether to apply ALF may be signaled on a per-coding unit basis, and the shape and filter coefficients of an ALF to be applied may vary for each block. In addition, an ALF filter having the same shape (a fixed shape) may be applied regardless of the characteristics of a target block to which the ALF filter is to be applied.

The prediction unit 150 includes an intra-prediction unit 152 and an inter-prediction unit 154. The intra-prediction unit 152 performs intra prediction within a current picture, and the inter-prediction unit 154 performs inter prediction to predict the current picture by using a reference picture stored in the decoded picture buffer 156. The intra-prediction unit 152 performs intra prediction from reconstructed regions in the current picture and transmits intra encoding information to the entropy coding unit 160. The intra encoding information may include at least one of an intra-prediction mode, a most probable mode (MPM) flag, an MPM index, and information regarding a reference sample. The inter-prediction unit 154 may again include a motion estimation unit 154a and a motion compensation unit 154b. The motion estimation unit 154a finds a part most similar to a current region with reference to a specific region of a reconstructed reference picture, and obtains a motion vector value which is the distance between the regions. Reference region-related motion information (reference direction indication information (L0 prediction, L1 prediction, or bidirectional prediction), a reference picture index, motion vector information, etc.) and the like, obtained by the motion estimation unit 154a, are transmitted to the entropy coding unit 160 so as to be included in a bitstream. The motion compensation unit 154B performs inter-motion compensation by using the motion information transmitted by the motion estimation unit 154a, to generate a prediction block for the current block. The inter-prediction unit 154 transmits the inter encoding information, which includes motion information related to the reference region, to the entropy coding unit 160.

According to an additional embodiment, the prediction unit 150 may include an intra block copy (IBC) prediction unit (not shown). The IBC prediction unit performs IBC prediction from reconstructed samples in a current picture and transmits IBC encoding information to the entropy coding unit 160. The IBC prediction unit references a specific region within a current picture to obtain a block vector value that indicates a reference region used to predict a current region. The IBC prediction unit may perform IBC prediction by using the obtained block vector value. The IBC prediction unit transmits the IBC encoding information to the entropy coding unit 160. The IBC encoding information may include at least one of reference region size information and block vector information (index information for predicting the block vector of a current block in a motion candidate list, and block vector difference information).

When the above picture prediction is performed, the transform unit 110 transforms a residual value between an original picture and a predictive picture to obtain a transform coefficient value. At this time, the transform may be performed on a specific block basis in the picture, and the size of the specific block may vary within a predetermined range. The quantization unit 115 quantizes the transform coefficient value generated by the transform unit 110 and transmits the quantized transform coefficient to the entropy coding unit 160.

The quantized transform coefficients in the form of a two-dimensional array may be rearranged into a one-dimensional array for entropy coding. In relation to methods for scanning a quantized transform coefficient, the size of a transform block and an intra-picture prediction mode may determine which scanning method is used. In an embodiment, diagonal, vertical, and horizontal scans may be applied. This scan information may be signaled on a block-by-block basis, and may be derived based on predetermined rules.

The entropy coding unit 160 generates a video signal bitstream by entropy coding information indicating a quantized transform coefficient, intra encoding information, and inter encoding information. The entropy coding unit 160 may use variable length coding (VLC) and arithmetic coding. The variable length coding (VLC) is a technique of transforming input symbols into consecutive codewords, wherein the length of the codewords is variable. For example, frequently occurring symbols are represented by shorter codewords, while less frequently occurring symbols are represented by longer codewords. As the variable length coding, context-based adaptive variable length coding (CAVLC) may be used. The arithmetic coding uses the probability distribution of each data symbol to transform consecutive data symbols into a single decimal number. The arithmetic coding allows acquisition of the optimal decimal bits needed to represent each symbol. As the arithmetic coding, context-based adaptive binary arithmetic coding (CABAC) may be used.

CABAC is a binary arithmetic coding technique using multiple context models generated based on probabilities obtained from experiments. First, when symbols are not in binary form, the encoder binarizes each symbol by using exp-Golomb, etc. The binarized value, 0 or 1, may be described as a bin. A CABAC initialization process is divided into context initialization and arithmetic coding initialization. The context initialization is the process of initializing the probability of occurrence of each symbol, and is determined by the type of symbol, a quantization parameter (QP), and slice type (I, P, or B). A context model having the initialization information may use a probability-based value obtained through an experiment. The context model provides information about the probability of occurrence of Least Probable Symbol (LPS) or Most Probable Symbol (MPS) for a symbol to be currently coded and about which of bin values 0 and 1 corresponds to the MPS (valMPS). One of multiple context models is selected via a context index (ctxIdx), and the context index may be derived from information in a current block to be encoded or from information about neighboring blocks. Initialization for binary arithmetic coding is performed based on a probability model selected from the context models. In the binary arithmetic coding, encoding is performed through the process in which division into probability intervals is made through the probability of occurrence of 0 and 1, and then a probability interval corresponding to a bin to be processed becomes the entire probability interval for the next bin to be processed. Information about a position within the last bin in which the last bin has been processed is output. However, the probability interval cannot be divided indefinitely, and thus, when the probability interval is reduced to a certain size, a renormalization process is performed to widen the probability interval and the corresponding position information is output. In addition, after each bin is processed, a probability update process may be performed, wherein information about a processed bin is used to set a new probability for the next to be processed.

The generated bitstream is encapsulated in network abstraction layer (NAL) unit as basic units. The NAL units are classified into video a coding layer (VCL) NAL unit, which includes video data, and a non-VCL NAL unit, which includes parameter information for decoding video data. There are various types of VCL or non-VCL NAL units. A NAL unit includes NAL header information and raw byte sequence payload (RBSP) which is data. The NAL header information includes summary information about the RBSP. The RBSP of a VCL NAL unit includes an integer number of encoded coding tree units. In order to decode a bitstream in a video decoder, it is necessary to separate the bitstream into NAL units and then decode each of the separate NAL units. Information required for decoding a video signal bitstream may be included in a picture parameter set (PPS), a sequence parameter set (SPS), a video parameter set (VPS), etc., and transmitted.

The block diagram of FIG. 1 illustrates the encoding device 100 according to an embodiment of the present disclosure, wherein the separately shown blocks logically distinguish the elements of the encoding device 100. Accordingly, the above-described elements of the encoding device 100 may be mounted as a single chip or multiple chips, depending on the design of the device. According to an embodiment, the above-described operation of each element of the encoding device 100 may be performed by a processor (not shown).

FIG. 2 is a schematic block diagram of a video signal decoding apparatus 200 according to an embodiment of the present invention. Referring to FIG. 2, the decoding apparatus 200 of the present invention includes an entropy decoding unit 210, an inverse quantization unit 220, an inverse transformation unit 225, a filtering unit 230, and a prediction unit 250.

The entropy decoding unit 210 entropy-decodes a video signal bitstream to extract transform coefficient information, intra encoding information, inter encoding information, and the like for each region. For example, the entropy decoding unit 210 may obtain a binarization code for transform coefficient information of a specific region from the video signal bitstream. The entropy decoding unit 210 obtains a quantized transform coefficient by inverse-binarizing a binary code. The inverse quantization unit 220 inverse-quantizes the quantized transform coefficient, and the inverse transformation unit 225 reconstructs a residual value by using the inverse-quantized transform coefficient. The video signal processing device 200 reconstructs an original pixel value by summing the residual value obtained by the inverse transformation unit 225 with a prediction value obtained by the prediction unit 250.

Meanwhile, the filtering unit 230 performs filtering on a picture to improve image quality. This may include a deblocking filter for reducing block distortion and/or an adaptive loop filter for removing distortion of the entire picture. The filtered picture is outputted or stored in the DPB 256 for use as a reference picture for the next picture.

The prediction unit 250 includes an intra prediction unit 252 and an inter prediction unit 254. The prediction unit 250 generates a prediction picture by using the encoding type decoded through the entropy decoding unit 210 described above, transform coefficients for each region, and intra/inter encoding information. In order to reconstruct a current block in which decoding is performed, a decoded region of the current picture or other pictures including the current block may be used. In a reconstruction, only a current picture, that is, a picture (or, tile/slice) that performs intra prediction or intra BC prediction, is called an intra picture or an I picture (or, tile/slice), and a picture (or, tile/slice) that can perform all of intra prediction, inter prediction, and intra BC prediction is called an inter picture (or, tile/slice). In order to predict sample values of each block among inter pictures (or, tiles/slices), a picture (or, tile/slice) using up to one motion vector and a reference picture index is called a predictive picture or P picture (or, tile/slice), and a picture (or tile/slice) using up to two motion vectors and a reference picture index is called a bi-predictive picture or a B picture (or tile/slice). In other words, the P picture (or, tile/slice) uses up to one motion information set to predict each block, and the B picture (or, tile/slice) uses up to two motion information sets to predict each block. Here, the motion information set includes one or more motion vectors and one reference picture index.

The intra prediction unit 252 generates a prediction block using the intra encoding information and reconstructed samples in the current picture. As described above, the intra encoding information may include at least one of an intra prediction mode, a Most Probable Mode (MPM) flag, and an MPM index. The intra prediction unit 252 predicts the sample values of the current block by using the reconstructed samples located on the left and/or upper side of the current block as reference samples. In this disclosure, reconstructed samples, reference samples, and samples of the current block may represent pixels. Also, sample values may represent pixel values.

According to an embodiment, the reference samples may be samples included in a neighboring block of the current block. For example, the reference samples may be samples adjacent to a left boundary of the current block and/or samples may be samples adjacent to an upper boundary. Also, the reference samples may be samples located on a line within a predetermined distance from the left boundary of the current block and/or samples located on a line within a predetermined distance from the upper boundary of the current block among the samples of neighboring blocks of the current block. In this case, the neighboring block of the current block may include the left (L) block, the upper (A) block, the below left (BL) block, the block, or the above left (AL) block.

The inter prediction unit 254 generates a prediction block using reference pictures and inter encoding information stored in the DPB 256. The inter coding information may include motion information set (reference picture index, motion vector information, etc.) of the current block for the reference block. Inter prediction may include L0 prediction, L1 prediction, and bi-prediction. L0 prediction means prediction using one reference picture included in the L0 picture list, and L1 prediction means prediction using one reference picture included in the L1 picture list. For this, one set of motion information (e.g., motion vector and reference picture index) may be required. In the bi-prediction method, up to two reference regions may be used, and the two reference regions may exist in the same reference picture or may exist in different pictures. That is, in the bi-prediction method, up to two sets of motion information (e.g., a motion vector and a reference picture index) may be used and two motion vectors may correspond to the same reference picture index or different reference picture indexes. In this case, the reference pictures are pictures located temporally before or after the current picture, and may be pictures for which reconstruction has already been completed. According to an embodiment, two reference regions used in the bi-prediction scheme may be regions selected from picture list L0 and picture list L1, respectively.

The inter prediction unit 254 may obtain a reference block of the current block using a motion vector and a reference picture index. The reference block is in a reference picture corresponding to a reference picture index. Also, a sample value of a block specified by a motion vector or an interpolated value thereof can be used as a predictor of the current block. For motion prediction with sub-pel unit pixel accuracy, for example, an 8-tap interpolation filter for a luma signal and a 4-tap interpolation filter for a chroma signal can be used. However, the interpolation filter for motion prediction in sub-pel units is not limited thereto. In this way, the inter prediction unit 254 performs motion compensation to predict the texture of the current unit from motion pictures reconstructed previously. In this case, the inter prediction unit may use a motion information set.

According to an additional embodiment, the prediction unit 250 may include an IBC prediction unit (not shown). The IBC prediction unit may reconstruct the current region by referring to a specific region including reconstructed samples in the current picture. The IBC prediction unit obtains IBC encoding information for the current region from the entropy decoding unit 210. The IBC prediction unit obtains a block vector value of the current region indicating the specific region in the current picture. The IBC prediction unit may perform IBC prediction by using the obtained block vector value. The IBC encoding information may include block vector information.

The reconstructed video picture is generated by adding the predict value outputted from the intra prediction unit 252 or the inter prediction unit 254 and the residual value outputted from the inverse transformation unit 225. That is, the video signal decoding apparatus 200 reconstructs the current block using the prediction block generated by the prediction unit 250 and the residual obtained from the inverse transformation unit 225.

Meanwhile, the block diagram of FIG. 2 shows a decoding apparatus 200 according to an embodiment of the present invention, and separately displayed blocks logically distinguish and show the elements of the decoding apparatus 200. Accordingly, the elements of the above-described decoding apparatus 200 may be mounted as one chip or as a plurality of chips depending on the design of the device. According to an embodiment, the operation of each element of the above-described decoding apparatus 200 may be performed by a processor (not shown).

The technology proposed in the present specification may be applied to a method and a device for both an encoder and a decoder, and the wording signaling and parsing may be for convenience of description. In general, signaling may be described as encoding each type of syntax from the perspective of the encoder, and parsing may be described as interpreting each type of syntax from the perspective of the decoder. In other words, each type of syntax may be included in a bitstream and signaled by the encoder, and the decoder may parse the syntax and use the syntax in a reconstruction process. In this case, the sequence of bits for each type of syntax arranged according to a prescribed hierarchical configuration may be called a bitstream.

One picture may be partitioned into sub-pictures, slices, tiles, etc. and encoded. A sub-picture may include one or more slices or tiles. When one picture is partitioned into multiple slices or tiles and encoded, all the slices or tiles within the picture must be decoded before the picture can be output a screen. On the other hand, when one picture is encoded into multiple subpictures, only a random subpicture may be decoded and output on the screen. A slice may include multiple tiles or subpictures. Alternatively, a tile may include multiple subpictures or slices. Subpictures, slices, and tiles may be encoded or decoded independently of each other, and thus are advantageous for parallel processing and processing speed improvement. However, there is the disadvantage in that a bit rate increases because encoded information of other adjacent subpictures, slices, and tiles is not available. A subpicture, a slice, and a tile may be partitioned into multiple coding tree units (CTUs) and encoded.

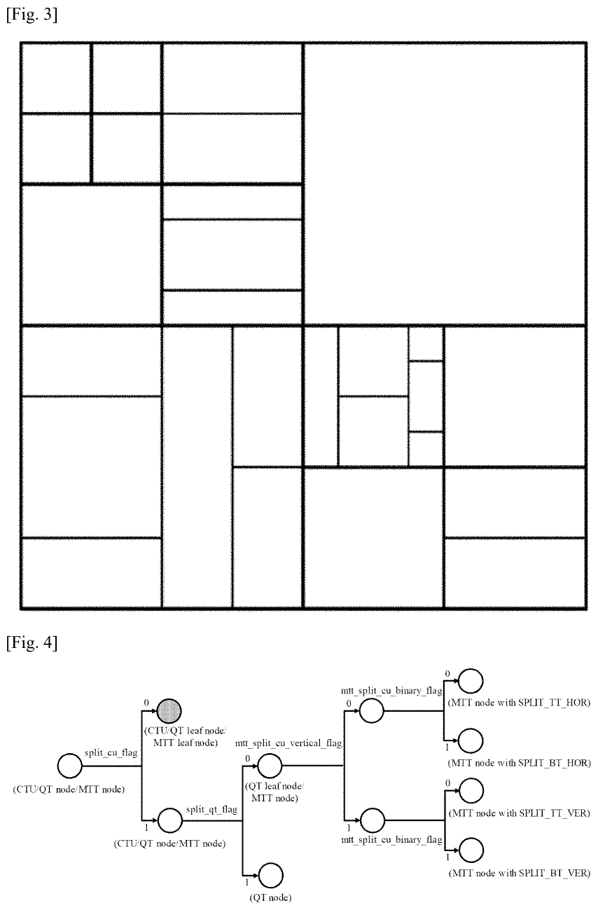

FIG. 3 illustrates an embodiment in which a coding tree unit (CTU) is divided into coding units (CUs) within a picture. In the process of coding a video signal, a picture may be divided into a sequence of coding tree units (CTUs). A coding tree unit may include a luma Coding Tree Block (CTB), two chroma coding tree blocks, and encoded syntax information thereof. One coding tree unit may include one coding unit, or one coding tree unit may be divided into multiple coding units. One coding unit may include a luma coding block (CB), two chroma coding blocks, and encoded syntax information thereof. One coding block may be partitioned into multiple sub-coding blocks. One coding unit may include one transform unit (TU), or one coding unit may be partitioned into multiple transform units. A transform unit may include a luma transform block (TB), two chroma transform blocks, and encoded syntax information thereof. A coding tree unit may be partitioned into multiple coding units. A coding tree unit may become a leaf node without being partitioned. In this case, the coding tree unit itself may be a coding unit.

The coding unit refers to a basic unit for processing a picture in the process of processing the video signal described above, that is, intra/inter prediction, transformation, quantization, and/or entropy coding. The size and shape of the coding unit in one picture may not be constant. The coding unit may have a square or rectangular shape. The rectangular coding unit (or rectangular block) includes a vertical coding unit (or vertical block) and a horizontal coding unit (or horizontal block). In the present specification, the vertical block is a block whose height is greater than the width, and the horizontal block is a block whose width is greater than the height. Further, in this specification, a non-square block may refer to a rectangular block, but the present invention is not limited thereto.

Referring to FIG. 3, the coding tree unit is first split into a quad tree (QT) structure. That is, one node having a 2N×2N size in a quad tree structure may be split into four nodes having an N×N size. In the present specification, the quad tree may also be referred to as a quaternary tree. Quad tree split can be performed recursively, and not all nodes need to be split with the same depth.

Meanwhile, the leaf node of the above-described quad tree may be further split into a multi-type tree (MTT) structure. According to an embodiment of the present invention, in a multi-type tree structure, one node may be split into a binary or ternary tree structure of horizontal or vertical division. That is, in the multi-type tree structure, there are four split structures such as vertical binary split, horizontal binary split, vertical ternary split, and horizontal ternary split. According to an embodiment of the present invention, in each of the tree structures, the width and height of the nodes may all have powers of 2. For example, in a binary tree (BT) structure, a node of a 2N×2N size may be split into two N×2N nodes by vertical binary split, and split into two 2N×N nodes by horizontal binary split. In addition, in a ternary tree (TT) structure, a node of a 2N×2N size is split into (N/2)×2N, N×2N, and (N/2)×2N nodes by vertical ternary split, and split into 2N×(N/2), 2N×N, and 2N×(N/2) nodes by horizontal ternary split. This multi-type tree split can be performed recursively.

A leaf node of the multi-type tree can be a coding unit. When the coding unit is not greater than the maximum transform length, the coding unit can be used as a unit of prediction and/or transform without further splitting. As an embodiment, when the width or height of the current coding unit is greater than the maximum transform length, the current coding unit can be split into a plurality of transform units without explicit signaling regarding splitting. On the other hand, at least one of the following parameters in the above-described quad tree and multi-type tree may be predefined or transmitted through a higher level set of RBSPs such as PPS, SPS, VPS, and the like. 1) CTU size: root node size of quad tree, 2) minimum QT size MinQtSize: minimum allowed QT leaf node size, 3) maximum BT size MaxBtSize: maximum allowed BT root node size, 4) Maximum TT size MaxTtSize: maximum allowed TT root node size, 5) Maximum MTT depth MaxMttDepth: maximum allowed depth of MTT split from QT's leaf node, 6) Minimum BT size MinBtSize: minimum allowed BT leaf node size, 7) Minimum TT size MinTtSize: minimum allowed TT leaf node size.

FIG. 4 illustrates an embodiment of a method of signaling splitting of the quad tree and multi-type tree. Preset flags can be used to signal the splitting of the quad tree and multi-type tree described above. Referring to FIG. 4, at least one of a flag ‘split_cu_flag’ indicating whether or not to split a node, a flag ‘split_qt_flag’ indicating whether or not to split a quad tree node, a flag ‘mtt_split_cu_vertical_flag’ indicating a splitting direction of the multi-type tree node, or a flag ‘mtt_split_cu_binary_flag’indicating a splitting shape of the multi-type tree node can be used.

According to an embodiment of the present invention, ‘split_cu_flag’, which is a flag indicating whether or not to split the current node, can be signaled first. When the value of ‘split_cu_flag’ is 0, it indicates that the current node is not split, and the current node becomes a coding unit. When the current node is the coating tree unit, the coding tree unit includes one unsplit coding unit. When the current node is a quad tree node ‘QT node’, the current node is a leaf node ‘QT leaf node’ of the quad tree and becomes the coding unit. When the current node is a multi-type tree node ‘MTT node’, the current node is a leaf node ‘MTT leaf node’ of the multi-type tree and becomes the coding unit.

When the value of ‘split_cu_flag’ is 1, the current node can be split into nodes of the quad tree or multi-type tree according to the value of ‘split_qt_flag’. A coding tree unit is a root node of the quad tree, and can be split into a quad tree structure first. In the quad tree structure, ‘split_qt_flag’ is signaled for each node ‘QT node’. When the value of ‘split_qt_flag’ is 1, the corresponding node is split into 4 square nodes, and when the value of ‘qt_split_flag’ is 0, the corresponding node becomes the ‘QT leaf node’ of the quad tree, and the corresponding node is split into multi-type nodes. According to an embodiment of the present invention, quad tree splitting can be limited according to the type of the current node. Quad tree splitting can be allowed when the current node is the coding tree unit (root node of the quad tree) or the quad tree node, and quad tree splitting may not be allowed when the current node is the multi-type tree node. Each quad tree leaf node ‘QT leaf node’ can be further split into a multi-type tree structure. As described above, when ‘split_qt_flag’ is 0, the current node can be split into multi-type nodes. In order to indicate the splitting direction and the splitting shape, ‘mtt_split_cu_vertical_flag’ and ‘mtt_split_cu_binary_flag’ can be signaled. When the value of ‘mtt_split_cu_vertical_flag’ is 1, vertical splitting of the node ‘MTT node’ is indicated, and when the value of ‘mtt_split_cu_vertical_flag’ is 0, horizontal splitting of the node ‘MTT node’ is indicated. In addition, when the value of ‘mtt_split_cu_binary_flag’ is 1, the node ‘MTT node’ is split into two rectangular nodes, and when the value of ‘mtt_split_cu_binary_flag’ is 0, the node ‘MTT node’ is split into three rectangular nodes.

In the tree partitioning structure, a luma block and a chroma block may be partitioned in the same form. That is, a chroma block may be partitioned by referring to the partitioning form of a luma block. When a current chroma block is less than a predetermined size, a chroma block may not be partitioned even if a luma block is partitioned.

In the tree partitioning structure, a luma block and a chroma block may have different forms. In this case, luma block partitioning information and chroma block partitioning information may be signaled separately. Furthermore, in addition to the partitioning information, luma block encoding information and chroma block encoding information may also be different from each other. In one example, the luma block and the chroma block may be different in at least one among intra encoding mode, encoding information for motion information, etc.

A node to be split into the smallest units may be treated as one coding block. When a current block is a coding block, the coding block may be partitioned into several sub-blocks (sub-coding blocks), and the sub-blocks may have the same prediction information or different pieces of prediction information. In one example, when a coding unit is in an intra mode, intra-prediction modes of sub-blocks may be the same or different from each other. Also, when the coding unit is in an inter mode, sub-blocks may have the same motion information or different pieces of the motion information. Furthermore, the sub-blocks may be encoded or decoded independently of each other. Each sub-block may be distinguished by a sub-block index (sbIdx). Also, when a coding unit is partitioned into sub-blocks, the coding unit may be partitioned horizontally, vertically, or diagonally. In an intra mode, a mode in which a current coding unit is partitioned into two or four sub-blocks horizontally or vertically is called intra sub-partitions (ISP). In an inter mode, a mode in which a current coding block is partitioned diagonally is called a geometric partitioning mode (GPM). In the GPM mode, the position and direction of a diagonal line are derived using a predetermined angle table, and index information of the angle table is signaled.

Picture prediction (motion compensation) for coding is performed on a coding unit that is no longer divided (i.e., a leaf node of a coding unit tree). Hereinafter, the basic unit for performing the prediction will be referred to as a “prediction unit” or a “prediction block”.

Hereinafter, the term “unit” used herein may replace the prediction unit, which is a basic unit for performing prediction. However, the present disclosure is not limited thereto, and “unit” may be understood as a concept broadly encompassing the coding unit.

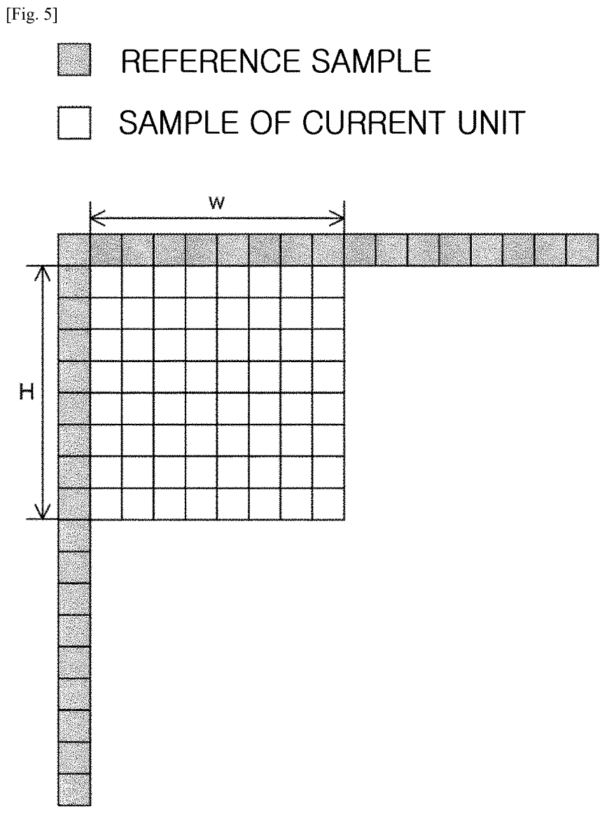

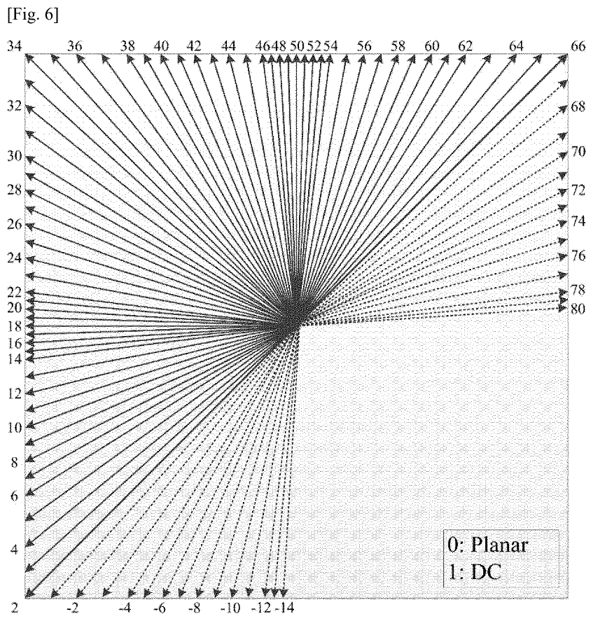

FIGS. 5 and 6 more specifically illustrate an intra prediction method according to an embodiment of the present invention. As described above, the intra prediction unit predicts the sample values of the current block by using the reconstructed samples located on the left and/or upper side of the current block as reference samples.

First, FIG. 5 shows an embodiment of reference samples used for prediction of a current block in an intra prediction mode. According to an embodiment, the reference samples may be samples adjacent to the left boundary of the current block and/or samples adjacent to the upper boundary. As shown in FIG. 5, when the size of the current block is W×H and samples of a single reference line adjacent to the current block are used for intra prediction, reference samples may be configured using a maximum of 2W+2H+1 neighboring samples located on the left and/or upper side of the current block.

Pixels from multiple reference lines may be used for intra prediction of the current block. The multiple reference lines may include n lines located within a predetermined range from the current block. According to an embodiment, when pixels from multiple reference lines are used for intra prediction, separate index information that indicates lines to be set as reference pixels may be signaled, and may be named a reference line index.

When at least some samples to be used as reference samples have not yet been reconstructed, the intra prediction unit may obtain reference samples by performing a reference sample padding procedure. The intra prediction unit may perform a reference sample filtering procedure to reduce an error in intra prediction. That is, filtering may be performed on neighboring samples and/or reference samples obtained by the reference sample padding procedure, so as to obtain the filtered reference samples. The intra prediction unit predicts samples of the current block by using the reference samples obtained as in the above. The intra prediction unit predicts samples of the current block by using unfiltered reference samples or filtered reference samples. In the present disclosure, neighboring samples may include samples on at least one reference line. For example, the neighboring samples may include adjacent samples on a line adjacent to the boundary of the current block.

Next, FIG. 6 shows an embodiment of prediction modes used for intra prediction. For intra prediction, intra prediction mode information indicating an intra prediction direction may be signaled. The intra prediction mode information indicates one of a plurality of intra prediction modes included in the intra prediction mode set. When the current block is an intra prediction block, the decoder receives intra prediction mode information of the current block from the bitstream. The intra prediction unit of the decoder performs intra prediction on the current block based on the extracted intra prediction mode information.

According to an embodiment of the present invention, the intra prediction mode set may include all intra prediction modes used in intra prediction (e.g., a total of 67 intra prediction modes). More specifically, the intra prediction mode set may include a planar mode, a DC mode, and a plurality (e.g., 65) of angle modes (i.e., directional modes). Each intra prediction mode may be indicated through a preset index (i.e., intra prediction mode index). For example, as shown in FIG. 6, the intra prediction mode index 0 indicates a planar mode, and the intra prediction mode index 1 indicates a DC mode. Also, the intra prediction mode indexes 2 to 66 may indicate different angle modes, respectively. The angle modes respectively indicate angles which are different from each other within a preset angle range. For example, the angle mode may indicate an angle within an angle range (i.e., a first angular range) between 45 degrees and −135 degrees clockwise. The angle mode may be defined based on the 12 o'clock direction. In this case, the intra prediction mode index 2 indicates a horizontal diagonal (HDIA) mode, the intra prediction mode index 18 indicates a horizontal (Horizontal, HOR) mode, the intra prediction mode index 34 indicates a diagonal (DIA) mode, the intra prediction mode index 50 indicates a vertical (VER) mode, and the intra prediction mode index 66 indicates a vertical diagonal (VDIA) mode.

Meanwhile, the preset angle range can be set differently depending on a shape of the current block. For example, if the current block is a rectangular block, a wide angle mode indicating an angle exceeding 45 degrees or less than −135 degrees in a clockwise direction can be additionally used. When the current block is a horizontal block, an angle mode can indicate an angle within an angle range (i.e., a second angle range) between (45+offset1) degrees and (−135+offset1) degrees in a clockwise direction. In this case, angle modes 67 to 76 outside the first angle range can be additionally used. In addition, if the current block is a vertical block, the angle mode can indicate an angle within an angle range (i.e., a third angle range) between (45−offset2) degrees and (−135−offset2) degrees in a clockwise direction. In this case, angle modes −10 to −1 outside the first angle range can be additionally used. According to an embodiment of the present disclosure, values of offset1 and offset2 can be determined differently depending on a ratio between the width and height of the rectangular block. In addition, offset1 and offset2 can be positive numbers.

According to a further embodiment of the present invention, a plurality of angle modes configuring the intra prediction mode set can include a basic angle mode and an extended angle mode. In this case, the extended angle mode can be determined based on the basic angle mode.

According to an embodiment, the basic angle mode is a mode corresponding to an angle used in intra prediction of the existing high efficiency video coding (HEVC) standard, and the extended angle mode can be a mode corresponding to an angle newly added in intra prediction of the next generation video codec standard. More specifically, the basic angle mode can be an angle mode corresponding to any one of the intra prediction modes {2, 4, 6, . . . , 66}, and the extended angle mode can be an angle mode corresponding to any one of the intra prediction modes {3, 5, 7, . . . , 65}. That is, the extended angle mode can be an angle mode between basic angle modes within the first angle range. Accordingly, the angle indicated by the extended angle mode can be determined on the basis of the angle indicated by the basic angle mode.

According to another embodiment, the basic angle mode can be a mode corresponding to an angle within a preset first angle range, and the extended angle mode can be a wide angle mode outside the first angle range. That is, the basic angle mode can be an angle mode corresponding to any one of the intra prediction modes {2, 3, 4, . . . , 66}, and the extended angle mode can be an angle mode corresponding to any one of the intra prediction modes {−14, −13, −12, . . . , −1} and {67, 68, . . . , 80}. The angle indicated by the extended angle mode can be determined as an angle on a side opposite to the angle indicated by the corresponding basic angle mode. Accordingly, the angle indicated by the extended angle mode can be determined on the basis of the angle indicated by the basic angle mode. Meanwhile, the number of extended angle modes is not limited thereto, and additional extended angles can be defined according to the size and/or shape of the current block. Meanwhile, the total number of intra prediction modes included in the intra prediction mode set can vary depending on the configuration of the basic angle mode and extended angle mode described above

In the embodiments described above, the spacing between the extended angle modes can be set on the basis of the spacing between the corresponding basic angle modes. For example, the spacing between the extended angle modes {3, 5, 7, . . . , 65} can be determined on the basis of the spacing between the corresponding basic angle modes {2, 4, 6, . . . , 66}. In addition, the spacing between the extended angle modes {−14, −13, . . . , −1} can be determined on the basis of the spacing between corresponding basic angle modes {53, 54, . . . , 66} on the opposite side, and the spacing between the extended angle modes {67, 68, . . . , 80} can be determined on the basis of the spacing between the corresponding basic angle modes {2, 3, 4, . . . , 15} on the opposite side. The angular spacing between the extended angle modes can be set to be the same as the angular spacing between the corresponding basic angle modes. In addition, the number of extended angle modes in the intra prediction mode set can be set to be less than or equal to the number of basic angle modes.

According to an embodiment of the present invention, the extended angle mode can be signaled based on the basic angle mode. For example, the wide angle mode (i.e., the extended angle mode) can replace at least one angle mode (i.e., the basic angle mode) within the first angle range. The basic angle mode to be replaced can be a corresponding angle mode on a side opposite to the wide angle mode. That is, the basic angle mode to be replaced is an angle mode that corresponds to an angle in an opposite direction to the angle indicated by the wide angle mode or that corresponds to an angle that differs by a preset offset index from the angle in the opposite direction. According to an embodiment of the present invention, the preset offset index is 1. The intra prediction mode index corresponding to the basic angle mode to be replaced can be remapped to the wide angle mode to signal the corresponding wide angle mode. For example, the wide angle modes {−14, −13, . . . , −1} can be signaled by the intra prediction mode indices {52, 53, . . . , 66}, respectively, and the wide angle modes {67, 68, . . . , 80} can be signaled by the intra prediction mode indices {2,3, . . . , 15}, respectively. In this way, the intra prediction mode index for the basic angle mode signals the extended angle mode, and thus the same set of intra prediction mode indices can be used for signaling the intra prediction mode even if the configuration of the angle modes used for intra prediction of each block are different from each other. Accordingly, signaling overhead due to a change in the intra prediction mode configuration can be minimized.

Meanwhile, whether or not to use the extended angle mode can be determined on the basis of at least one of the shape and size of the current block. According to an embodiment, when the size of the current block is greater than a preset size, the extended angle mode can be used for intra prediction of the current block, otherwise, only the basic angle mode can be used for intra prediction of the current block. According to another embodiment, when the current block is a block other than a square, the extended angle mode can be used for intra prediction of the current block, and when the current block is a square block, only the basic angle mode can be used for intra prediction of the current block.

The intra-prediction unit determines reference samples and/or interpolated reference samples to be used for intra prediction of the current block, based on the intra-prediction mode information of the current block. When the intra-prediction mode index indicates a specific angular mode, a reference sample corresponding to the specific angle or an interpolated reference sample from current samples in the current block is used for prediction of a current pixel. Thus, different sets of reference samples and/or interpolated reference samples may be used for intra prediction depending on the intra-prediction mode. After the intra prediction of the current block is performed using the reference samples and the intra-prediction mode information, the decoder reconstructs sample values of the current block by adding the residual signal of the current block, which has been obtained from the inverse transform unit, to the intra-prediction value of the current block.

Motion information used for inter prediction may include reference direction indication information (inter_pred_idc), reference picture index (ref_idx_10, ref_idx_11), and motion vector (mvL0, mvL1). Reference picture list utilization information (predFlagL0, predFlagL1) may be set based on the reference direction indication information. In one example, for a unidirectional prediction using an L0 reference picture, predFlagL0=1 and predFlagL1=0 may be set. For a unidirectional prediction using an L1 reference picture, predFlagL0=0 and predFlagL1=1 may be set. For bidirectional prediction using both the L0 and L1 reference pictures, predFlagL0=1 and predFlagL1=1 may be set.

When the current block is a coding unit, the coding unit may be partitioned into multiple sub-blocks, and the sub-blocks have the same prediction information or different pieces of prediction information. In one example, when the coding unit is in an intra mode, intra-prediction modes of the sub-blocks may be the same or different from each other. Also, when the coding unit is in an inter mode, the sub-blocks may have the same motion information or different pieces of motion information. Furthermore, the sub-blocks may be encoded or decoded independently of each other. Each sub-block may be distinguished by a sub-block index (sbIdx).

The motion vector of the current block is likely to be similar to the motion vector of a neighboring block. Therefore, the motion vector of the neighboring block may be used as a motion vector predictor (MVP), and the motion vector of the current block may be derived using the motion vector of the neighboring block. Furthermore, to improve the accuracy of the motion vector, the motion vector difference (MVD) between the optimal motion vector of the current block and the motion vector predictor found by the encoder from an original video may be signaled.

The motion vector may have various resolutions, and the resolution of the motion vector may vary on a block-by-block basis. The motion vector resolution may be expressed in integer units, half-pixel units, ¼ pixel units, 1/16 pixel units, 4-integer pixel units, etc. A video, such as screen content, has a simple graphical form such as text, and does not require an interpolation filter to be applied. Thus, integer units and 4-integer pixel units may be selectively applied on a block-by-block basis. A block encoded using an affine mode, which represent rotation and scale, exhibit significant changes in form, so integer units, ¼ pixel units, and 1/16 pixel units may be applied selectively on a block-by-block basis. Information about whether to selectively apply motion vector resolution on a block-by-block basis is signaled by amvr_flag. If applied, information about a motion vector resolution to be applied to the current block is signaled by amvr_precision_idx.

In the case of blocks to which bidirectional prediction is applied, weights applied between two prediction blocks may be equal or different when applying the weighted average, and information about the weights is signaled via BCW_IDX.

In order to improve the accuracy of the motion vector predictor, a merge or AMVP(advanced motion vector prediction) method may be selectively used on a block-by-block basis. The merge method is a method that configures motion information of a current block to be the same as motion information of a neighboring block adjacent to the current block, and is advantageous in that the motion information is spatially propagated without change in a motion region with homogeneity, and thus the encoding efficiency of the motion information is increased. On the other hand, the AMVP method is a method for predicting motion information in L0 and L1 prediction directions respectively and signaling the most optimal motion information in order to represent accurate motion information. The decoder derives motion information for a current block by using the AMVP or merge method, and then uses a reference block, located in the motion information in a reference picture, as a prediction block for the current block.

A method of deriving motion information in Merge or AMVP involves a method for constructing a motion candidate list using motion vector predictors derived from neighboring blocks of the current block, and then signaling index information for the optimal motion candidate. In the case of AMVP, motion candidate lists are derived for L0 and L1, respectively, so the most optimal motion candidate indexes (mvp_10_flag, mvp_11_flag) for L0 and L1 are signaled, respectively. In the case of Merge, a single move candidate list is derived, so a single merge index (merge_idx) is signaled. There may be various motion candidate lists derived from a single coding unit, and a motion candidate index or a merge index may be signaled for each motion candidate list. In this case, a mode in which there is no information about residual blocks in blocks encoded using the merge mode may be called a MergeSkip mode.

The motion candidate and the motion information candidate of this specification may have the same meaning. In addition, the motion candidate list and the motion information candidate list of this specification may have the same meaning.

Symmetric MVD (SMVD) is a method which makes motion vector difference (MVD) values in the L0 and L1 directions symmetrical in the case of bi-directional prediction, thereby reducing the bit rate of motion information transmitted. The MVD information in the L1 direction that is symmetrical to the L0 direction is not transmitted, and reference picture information in the L0 and L1 directions is also not transmitted, but is derived during decoding.

Overlapped block motion compensation (OBMC) is a method in which, when blocks have different pieces of motion information, prediction blocks for a current block are generated by using motion information of neighboring blocks, and the prediction blocks are then weighted averaged to generate a final prediction block for the current block. This has the effect of reducing the blocking phenomenon that occurs at the block edges in a motion-compensated video.

Generally, a merged motion candidate has low motion accuracy. To improve the accuracy of the merge motion candidate, a merge mode with MVD (MMVD) method may be used. The MMVD method is a method for correcting motion information by using one candidate selected from several motion difference value candidates. Information about a correction value of the motion information obtained by the MMVD method (e.g., an index indicating one candidate selected from among the motion difference value candidates, etc.) may be included in a bitstream and transmitted to the decoder. By including the information about the correction value of the motion information in the bitstream, a bit rate may be saved compared to including an existing motion information difference value in a bitstream.

A template matching (TM) method is a method of configuring a template through a neighboring pixel of a current block, searching for a matching area most similar to the template, and correcting motion information. Template matching (TM) is a method of performing motion prediction by a decoder without including motion information in a bitstream so as to reduce the size of an encoded bitstream. The decoder does not have an original image, and thus may schematically derive motion information of a current block by using a pre-reconstructed neighboring block.

A Decoder-side Motion Vector Refinement (DMVR) method is a method for correcting motion information through the correlation of already reconstructed reference videos in order to find more accurate motion information. The DMVR method is a method which uses the bidirectional motion information of a current block to use, within predetermined regions of two reference pictures, a point with the best matching between reference blocks in the reference pictures as a new bidirectional motion. When the DMVR method is performed, the encoder may perform DMVR on one block to correct motion information, and then partition the block into sub-blocks and perform DMVR on each sub-block to correct motion information of the sub-block again, and this may be referred to as multi-pass DMVR (MP-DMVR).

A local illumination compensation (LIC) method is a method for compensating for changes in luma between blocks, and is a method which derives a linear model by using neighboring pixels adjacent to a current block, and then compensate for luma information of the current block by using the linear model.

Existing video encoding methods perform motion compensation by considering only parallel movements in upward, downward, leftward, and rightward directions, thus reducing the encoding efficiency when encoding videos that include movements such as zooming, scaling, and rotation that are commonly encountered in real life. To express the movements such as zooming, scaling, and rotation, affine model-based motion prediction techniques using four (rotation) or six (zooming, scaling, rotation) parameter models may be applied.

Bi-directional optical flow (BDOF) is used to correct a prediction block by estimating the amount of change in pixels on an optical-flow basis from a reference block of blocks with bi-directional motion. Motion information derived by the BDOF of VVC may be used to correct the motion of a current block.

Prediction refinement with optical flow (PROF) is a technique for improving the accuracy of affine motion prediction for each sub-block so as to be similar to the accuracy of motion prediction for each pixel. Similar to BDOF, PROF is a technique that obtains a final prediction signal by calculating a correction value for each pixel with respect to pixel values in which affine motion is compensated for each sub-block based on optical-flow.

The combined inter-/intra-picture prediction (CIIP) method is a method for generating a final prediction block by performing weighted averaging of a prediction block generated by an intra-picture prediction method and a prediction block generated by an inter-picture prediction method when generating a prediction block for the current block.

The intra block copy (IBC) method is a method for finding a part, which is most similar to a current block, in an already reconstructed region within a current picture and using the reference block as a prediction block for the current block. In this case, information related to a block vector, which is the distance between the current block and the reference block, may be included in a bitstream. The decoder can parse the information related to the block vector contained in the bitstream to calculate or set the block vector for the current block.

The bi-prediction with CU-level weights (BCW) method is a method in which with respect to two motion-compensated prediction blocks from different reference pictures, weighted averaging of the two prediction blocks is performed by adaptively applying weights on a block-by-block basis without generating the prediction blocks using an average.

The multi-hypothesis prediction (MHP) method is a method for performing weighted prediction through various prediction signals by transmitting additional motion information in addition to unidirectional and bidirectional motion information during inter-picture prediction.

The cross-component linear model (CCLM) is a method that constructs a linear model by using the high correlation between a luma signal and a chroma signal at the same position as the luma signal, and then predict the chroma signal by using the linear model. A template is constructed using a block, which has been completely reconstructed, among neighboring blocks adjacent to a current block, and parameters for the linear model are derived through the template. Next, a current luma block, selectively reconstructed based on video formats so as to fit the size of a chroma block, is downsampled. Finally, the downsampled luma block and the corresponding linear model are used to predict a chroma block of the current block. In this case, a method using two or more linear models is referred to as multi-model linear mode (MMLM).

In independent scalar quantization, a reconstructed coefficient t′k for an input coefficient tk depends only on a related quantization index qk. That is, a quantization index for a random reconstructed coefficient has a different value from quantization indexes for other reconstructed coefficients. Here, t′k may be a value that includes a quantization error in tk, and may be different or the same depending on quantization parameters. Here, t′k may be called a reconstructed transform coefficient or a dequantized transform coefficient, and the quantization index may be called a quantized transform coefficient.

In uniform reconstruction quantization (URQ), reconstructed coefficients have the characteristic of being arrangement at equal intervals. The distance between two adjacent reconstructed values may be called a quantization step size. The reconstructed values may include 0, and the entire set of available reconstructed values may be uniquely defined based on the quantization step size. The quantization step size may vary depending on quantization parameters. In the existing methods, quantization reduces the set of acceptable reconstructed transform coefficients, and elements of the set may be finite. Thus, there are limitation in minimizing the average error between an original video and a reconstructed video. Vector quantization may be used as a method for minimizing the average error.

A simple form of vector quantization used in video encoding is sign data hiding. This is a method in which the encoder does not encode a sign for one non-zero coefficient and the decoder determines the sign for the coefficient based on whether the sum of absolute values of all the coefficients is even or odd. To this end, in the encoder, at least one coefficient may be incremented or decremented by “1”, and the at least one coefficient may be selected and have a value adjusted so as to be optimal from the perspective of rate-distortion cost. In one example, a coefficient with a value close to the boundary between the quantization intervals may be selected.

Another vector quantization method is trellis-coded quantization, and, in video encoding, is used as an optimal path-searching technique to obtain optimized quantization values in dependent quantization. On a block-by-block basis, quantization candidates for all coefficients in a block are placed in a trellis graph, and the optimal trellis path between optimized quantization candidates is found by considering rate-distortion cost. Specifically, the dependent quantization applied to video encoding may be designed such that a set of acceptable reconstructed transform coefficients with respect to transform coefficients depends on the value of a transform coefficient that precedes a current transform coefficient in the reconstruction order. At this time, by selectively using multiple quantizers according to the transform coefficients, the average error between the original video and the reconstructed video is minimized, thereby increasing the encoding efficiency.

Among intra prediction encoding techniques, the matrix intra prediction (MIP) method is a matrix-based intra prediction method, and obtains a prediction signal by using a predefined matrix and offset values through pixels on the left and top of a neighboring block, unlike a prediction method having directionality from pixels of neighboring blocks adjacent to a current bloc.

To derive an intra-prediction mode for a current block, on the basis of a template which is a random reconstructed region adjacent to the current block, an intra-prediction mode for a template derived through neighboring pixels of the template may be used to reconstruct the current block. First, the decoder may generate a prediction template for the template by using neighboring pixels (references) adjacent to the template, and may use an intra-prediction mode, which has generated the most similar prediction template to an already reconstructed template, to reconstruct the current block. This method may be referred to as template intra mode derivation (TIMD).

In general, the encoder may determine a prediction mode for generating a prediction block and generate a bitstream including information about the determined prediction mode. The decoder may parse a received bitstream to set an intra-prediction mode. In this case, the bit rate of information about the prediction mode may be approximately 10% of the total bitstream size. To reduce the bit rate of information about the prediction mode, the encoder may not include information about an intra-prediction mode in the bitstream. Accordingly, the decoder may use the characteristics of neighboring blocks to derive (determine) an intra-prediction mode for reconstruction of a current block, and may use the derived intra-prediction mode to reconstruct the current block. In this case, to derive the intra-prediction mode, the decoder may apply a Sobel filter horizontally and vertically to each neighboring pixel adjacent to the current block to infer directional information, and then map the directional information to the intra-prediction mode. The method by which the decoder derives the intra-prediction mode using neighboring blocks may be described as decoder side intra mode derivation (DIMD).

A block predicted by using the intra prediction directional mode may have discontinuous edges at the above and left boundaries of the block. For example, if the current block is predicted by using vertical direction mode, discontinuous edges may exist at the left boundary of the block. To mitigate this discontinuity, the encoder and decoder may apply filtering to the samples at the boundary inside the prediction block. The filtering may determine whether to apply the filtering and/or the filtering weight by using at least one of a reconstructed sample adjacent to the current prediction block, location information of the reconstructed sample adjacent to the current prediction block, a sample at a boundary inside the current prediction block, location information of the sample at a boundary inside the current prediction block, the intra prediction directional mode of the current prediction block, and the horizontal size and the vertical size of the current prediction block. The filtering weight refer to the weight for a sample at a boundary inside the current prediction block and the weight for a reconstructed sample adjacent to the current prediction block. This filtering method may be referred to as position dependent prediction combination (PDPC).

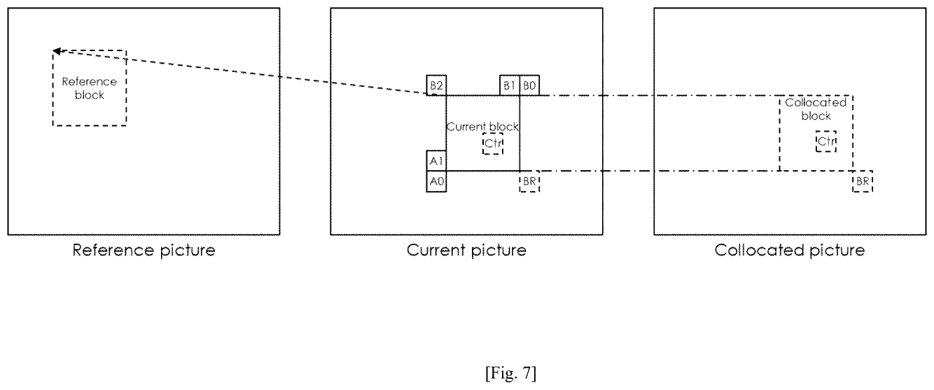

FIG. 7 illustrates the position of neighboring blocks used to construct a motion candidate list in inter prediction.

The neighboring blocks may be spatially located blocks or temporally located blocks. A neighboring block that is spatially adjacent to a current block may be at least one among a left (A1) block, a left below (A0) block, an above (B1) block, an above right (BO) block, or an above left (B2) block. A neighboring block that is temporally adjacent to the current block may be a block in a collocated picture, which includes the position of a top left pixel of a bottom right (BR) block of the current block. When a neighboring block temporally adjacent to the current block is encoded using an intra mode, or when the neighboring block temporally adjacent to the current block is positioned not to be used, a block, which includes a horizontal and vertical center (Ctr) pixel position in the current block, in the collocated picture corresponding to the current picture may be used as a temporal neighboring block. Motion candidate information derived from the collocated picture may be referred to as a temporal motion vector predictor (TMVP). Only one TMVP may be derived from one block. One block may be partitioned into multiple sub-blocks, and a TMVP candidate may be derived for each sub-block. A method for deriving TMVPs on a sub-block basis may be referred to as sub-block temporal motion vector predictor (sbTMVP).

Whether methods described in the present specification are to be applied may be determined on the basis of at least one of pieces of information relating to slice type information (e.g., whether a slice is an I slice, a P slice, or a B slice), whether the current block is a tile, whether the current block is a subpicture, the size of a current block, the depth of a coding unit, whether a current block is a luma block or a chroma block, whether a frame is a reference frame or a non-reference frame, and a temporal layer corresponding a reference sequence and a layer. Pieces of information used to determine whether methods described in the present specification are to be applied may be pieces of information promised between a decoder and an encoder in advance. In addition, such pieces of information may be determined according to a profile and a level. Such pieces of information may be expressed by a variable value, and a bitstream may include information on a variable value. That is, a decoder may parse information on a variable value included in a bitstream to determine whether the above methods are applied. For example, whether the above methods are to be applied may be determined on the basis of the width length or the height length of a coding unit. If the width length or the height length is equal to or greater than 32 (e.g., 32, 64, or 128), the above methods may be applied. If the width length or the height length is smaller than 32 (e.g., 2, 4, 8, or 16), the above methods may be applied. If the width length or the height length is equal to 4 or 8, the above methods may be applied.

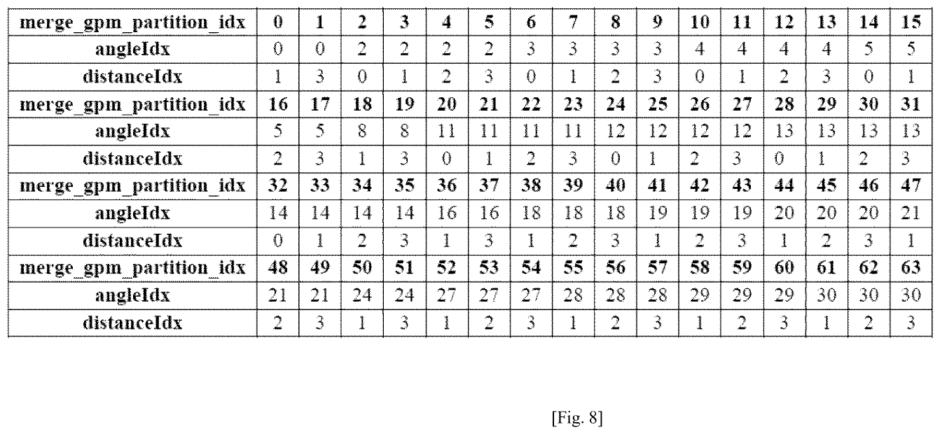

FIG. 8 illustrates a syntax for signaling by integrating the angle of a reference line and the distance of the reference line from the center position in the GPM mode, and specific information signaled by the syntax according to an embodiment of the disclosure.

As described above, the GPM mode is a prediction mode in which the current block is divided into multiple areas, for example, two areas, according to the reference line, and prediction is performed for each area. In this case, each divided area may be one of a triangle, a square, or a pentagon. The encoder may include a syntax element (merge_gpm_partition_idx) indicating to which angle the reference line used in the GPM mode corresponds, and indicating how far the reference line is from the center of the current block in the bitstream. For convenience of description, this syntax element is referred to as the merge GPM partition index. The decoder may obtain the merge GPM partition index from the bitstream, and determine the shape of the area in which the current block is divided in the GMP mode according to the merge GPM partition index. Specifically, the decoder may determine the angle of the reference line dividing the current block into two areas and the distance from the reference line to the center of the current block based on the merge GPM partition index. The merge GPM partition index may indicate the angle of the reference line and the distance from the reference line to the center of the current block according to a pre-specified table. In a specific embodiment, the merge GPM partition index may have values of 0 to 63. The pre-specified table may be as illustrated in FIG. 8.

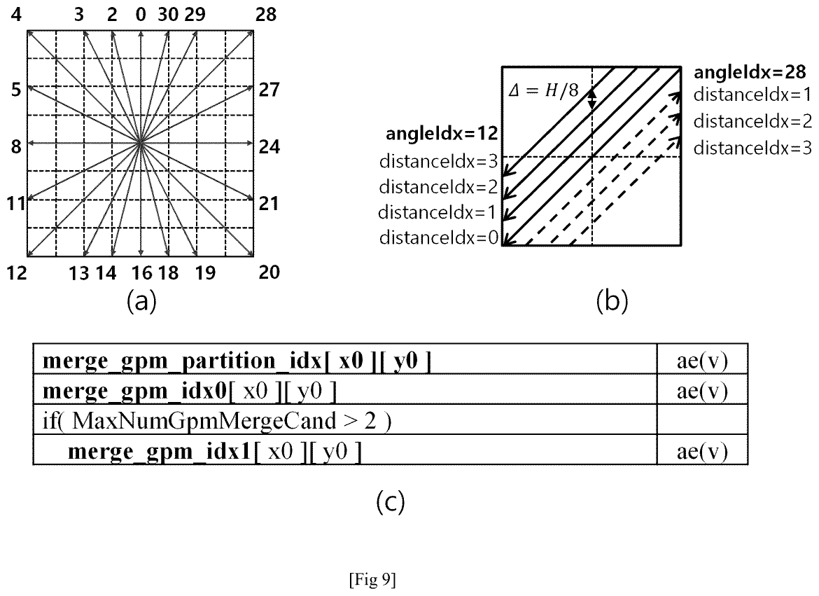

FIG. 9 illustrates a reference line according to the value of the merge GPM partition index, and a syntax indicating information on the GPM mode in an embodiment of the disclosure.

(a) and (b) of FIG. 9 illustrate a reference line according to the value of the merge GPM partition index described in FIG. 8, and illustrate a syntax indicating information about the GPM mode. When an area divided in the GPM mode is encoded in the inter prediction mode, the bitstream may include motion information corresponding to an area encoded in the inter prediction mode, such as information indicating one motion vector in the motion candidate list, as well as the merge GPM partition index. In (c) of FIG. 9, merge_gpm_idx0 is an index indicating the motion vector of the first area in the motion candidate list, and merge_gpm_idx1 is an index indicating the motion vector of the second area in the motion candidate list.

Each divided area in the GPM mode may be encoded in an intra prediction mode or an inter prediction mode. The encoder may include information related to the prediction directional mode of the area encoded in the intra prediction mode in the bitstream. The information related to the prediction directional mode may include at least one of information on whether the corresponding area is encoded in DIMD mode, information on whether the corresponding area is encoded in TIMD mode, information on whether the corresponding area is encoded in MIP mode, information on which reference pixel line the corresponding area is encoded using, information on whether the corresponding area is encoded by using ISP mode, information on which partition shape of ISP mode the corresponding area uses, information on the MPM list used for encoding the corresponding area, and information on which intra prediction directional mode the corresponding area uses. The decoder may obtain information related to the prediction directional mode of the area encoded in the intra prediction mode from the bitstream and generate a prediction block based on the information related to the prediction directional mode.

The encoder may include motion information of the area encoded in the inter prediction mode, for example, information related to a motion vector, in the bitstream. The information related to the motion information may include at least one of information on whether the corresponding area is encoded by using TM, information on whether the corresponding area is encoded by using AMVP or merge mode, information on whether the corresponding area is encoded by using IBC mode, information on whether the corresponding area is encoded by using intra TMP mode, information on whether the corresponding area is encoded by using affine mode, information on whether the corresponding area is encoded by using SMVD mode, reference direction indication information used to encode the corresponding area, information on which reference picture the corresponding area is encoded using, information related to the differential value of the motion information used to encode the corresponding area, information related to AMVR used to encode the corresponding area, information related to MMVD used to encode the corresponding area, index information indicating which motion candidate is used among the motion candidate lists used encode the corresponding area, and information related to BCW used to encode the corresponding area. The decoder may obtain information related to motion information of an area encoded in the inter prediction mode from the bitstream, and generate a prediction block based on information related to the motion information.

In the GPM mode, an individual area may be divided into two or four areas and encoded again by applying the ISP mode. The bitstream may include information indicating in which direction the area using the ISP mode is divided and encoded. The decoder may determine in which direction the area is divided in the ISP mode based on the corresponding information. In the above-described embodiments, when the corresponding area is divided into a rectangular shape in the GMP mode, the ISP mode may be used for encoding the corresponding area.

The encoder may not include information related to the ISP mode in the bitstream when the current block is in a GPM mode that is not divided into a rectangular shape. The decoder may not parse information related to the ISP mode in the GPM mode that is not divided into a square shape. In addition, for an area in the GPM mode that is not divided into a rectangular shape, the encoder may infer that the area is not encoded by using the ISP mode.

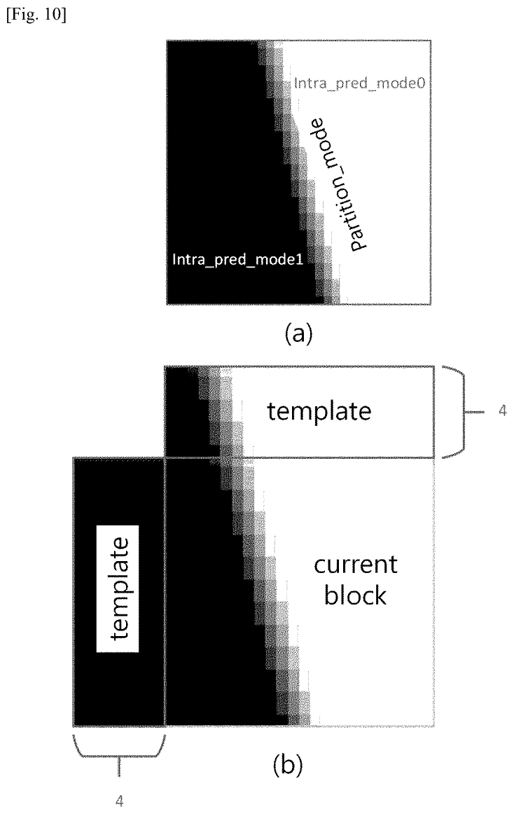

FIG. 10 illustrates a method of deriving a GPM partition shape and an intra prediction mode, based on a template according to an embodiment of the disclosure.

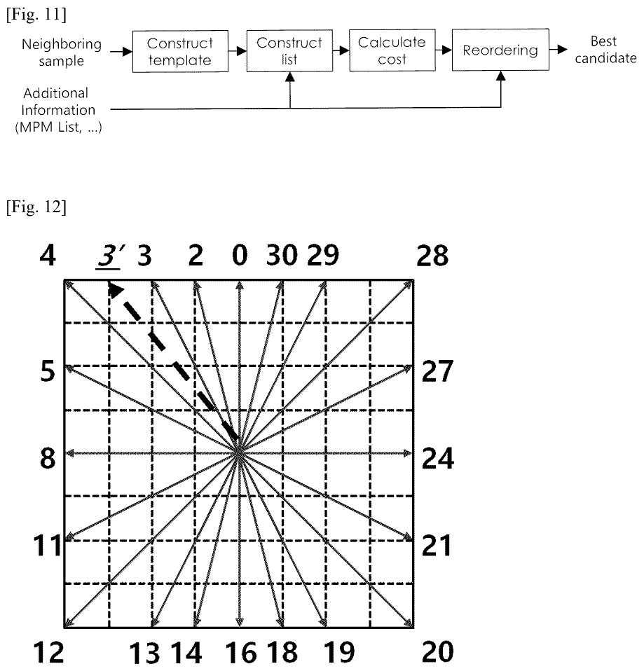

When the encoder encodes both of two areas, which are divided in the GPM mode, in the intra prediction mode, information related to the intra prediction directional mode and information related to the partition shape for each area may be signaled separately or encoded through a template-based derivation method. (a) of FIG. 10 illustrates a method of signaling the encoding information for each area separately. The encoder may include information related to the partition shape (partition_mode) and information related to the intra prediction directional mode of each area (intra_pred_mode0 and intra_pred_mode1) in the bitstream. The decoder may parse information related to the partition shape and information related to the intra prediction directional mode from the bitstream, and then generate a prediction block for the current block by using the corresponding information. (b) of FIG. 10 illustrates a method for deriving information related to the intra prediction directional mode and information related to the partition shape for each area, based on a template, and details are described in FIG. 11.

FIG. 11 illustrates a method of deriving a GPM and an intra prediction directional mode, based on a template according to an embodiment of the disclosure.

In order to reduce the amount of bits required for signaling, a template-based prediction method may be used by the encoder and decoder as illustrated in (b) of FIG. 10. The template-based prediction method performs prediction by using the already reconstructed peripheral pixels of the current block for information related to the partition shape and intra prediction directional mode for each area of the current block. First, the encoder and decoder construct a reference template by using the already reconstructed peripheral pixel of the current block. The reference template may be composed of a left template of the current block and an upper template of the current block. The size of the left template may be M×the height of the current block, and the size of the upper template may be the width of the current block×M. In this case, M may be an integer greater than or equal to 1, for example, 4. Next, the encoder and decoder construct a GPM partition prediction candidate list by using the 64 partition shapes available for the current block and the intra prediction directional information for each area. In this case, each candidate of the GPM partition prediction candidate list may include information on the partition shape of the current block (e.g., merge_gpm_partition_idx of FIG. 8) and information related to the intra prediction directional mode for two areas (e.g., intra_pred_mode0 and intra_pred_model of (a) of FIG. 10). Therefore, when generating the GPM partition prediction candidate list for predicting an area predicted through intra prediction, the encoder and decoder may generate candidates for each combination of the partition shape and the intra prediction directional mode. Next, the encoder and decoder use information on all candidates in the GPM partition prediction candidate list to predict the reference template by using the neighboring pixels of the reference template to construct a prediction template. The similarity between the reference template and the prediction template is calculated and a cost value is output. In this case, the cost value may be calculated by using sum of absolute differences (SAD) or mean-removed SAD (MR-SAD). After calculating cost values for all candidates in the GPM partition prediction candidate list, the decoder and encoder may rearrange the GPM partition prediction candidate list in ascending order based on the cost value. The encoder may include the index of a candidate most suitable for the current block among candidates in the rearranged GPM partition prediction candidate list in the bitstream. Alternatively, the candidate with the lowest cost value in the rearranged GPM partition prediction candidate list may be used for encoding. Through this, information indicating one candidate in the GPM partition prediction candidate list may not be indicated.

The decoder may parse the optimal candidate index information for the current block from the bitstream and predict the current block by using the prediction information of the candidate indicated by the optimal candidate index from the rearranged GPM partition prediction candidate list generated in the same way as the encoder, for example, information on the partition shape of the current block, and information related to the merge_gpm_partition_idx of FIG. 8 and the intra prediction directional mode for the two areas, for example, intra_pred_mode0 and intra_pred_model of (a) of FIG. 10. In another specific embodiment, after constructing the rearranged GPM partition prediction candidate list, the decoder may predict the current block by using the candidate with the lowest cost value as the optimal candidate.

The number of candidates that may be included in the GPM partition prediction candidate list is a combination of 64 GPM partition shapes and 67 intra prediction directional modes for each area, so there may be a total of about 280,000 candidates, which is 64×67×66 (assuming that the intra prediction directional modes are different between areas). In order to reduce complexity, the cost may be calculated only for some candidates. The encoder and decoder may select some candidates based on at least one of the size of the current block, the width or height of the current block, the number of pixels of the current block, whether the current block is a luminance signal or a chrominance signal, the intra prediction directional mode of the neighboring block adjacent to the current block, the MPM list for the current block, the intra prediction directional mode derived from DIMD or TIMD, and the GPM partition method for the neighboring block adjacent to the current block. In a specific embodiment, the encoder and decoder may construct the GPM partition prediction candidate list by using only the intra prediction directional mode in the MPM list for the current block, without constructing the GPM partition prediction candidate list by using all intra prediction directional modes. In another specific embodiment, the encoder and decoder may construct the GPM partition prediction candidate list using at least one of the intra prediction directional modes derived from DIMD or TIMD. When the encoder and decoder derive the intra prediction mode from a neighboring block, if the encoding mode of the neighboring block is encoded in the TIMD mode or the TMRL mode, the intra prediction mode in which the range of the intra prediction mode of the neighboring block is extended from the existing 67 to 131 is used. In this case, the encoder and decoder may reduce the precision of the intra prediction mode to the existing 67 modes, and then construct the GPM partition prediction candidate list by using the changed intra prediction mode. In another specific embodiment, the encoder and decoder may construct the GPM partition prediction candidate list by using the extended range of intra prediction modes without any changes. The details of TMRL are described later.

In another specific embodiment, the encoder and decoder may construct the GPM partition prediction candidate list by using some partition shapes, without constructing the GPM partition prediction candidate list by using all partition shapes. Specifically, the encoder and decoder may not include the GPM partition in which the number of pixels in arbitrary divided area is within a pre-specified number in the GPM partition prediction candidate list. In this case, the pre-specified number may be an integer greater than or equal to 1. Specifically, the pre-specified number may be 10. In another specific embodiment, the encoder and decoder may not include the GPM partition in which the sum of the absolute value of the x-axis difference value (ex-sx) and the absolute value of the y-axis difference value (ey-sy) between the start position (sx, sy) and the end position (ex, ey) of the reference line used for partition is within a pre-specified value, or the length of the reference line is within a pre-specified value in the GPM partition prediction candidate list. In this case, the pre-specified value may be an integer greater than or equal to 1. Specifically, the pre-specified value may be 3.

When the number of candidates in the GPM partition prediction candidate list is increased, the encoding efficiency is high, but the complexity may also increase. In order to reduce the increase in complexity, the encoder may categorize the characteristics of the GPM partition prediction candidate list for the current block into several categories and then include information related to the categorization in the bitstream. The decoder may parse classification-related information from the bitstream and then construct a GPM partition prediction candidate list for the current block based on the classification-related information. In this case, the criterion for classifying the characteristics of the GPM partition prediction candidate list may include at least one of the complexity between pixels of two areas divided in the GPM or the intra prediction directional mode. In this case, the complexity may be calculated based on the absolute sum between pixels in the area. When the absolute sum is greater than a pre-specified value, the encoder and decoder may determine that the complexity of the corresponding area is large. In addition, when the absolute sum is equal to or less than a pre-specified value, the encoder and decoder may determine that the complexity of the corresponding area is large. The pre-specified value may be determined based on the number of pixels of the current block. In addition, the pre-specified value may be an integer greater than or equal to 1. In another specific embodiment, the complexity may be calculated based on whether the predicted directional mode is an angular mode, a non-directional mode, or a MIP mode. In this case, the non-directional mode may include at least one of a DC mode and a planar mode.

The intra prediction directional mode allowed by the classified group may vary through the embodiments described above. In addition, the partition shape allowed in the GPM mode may vary by the classified group. Specifically, an area included in a low complexity group may not be allowed to be encoded by using the intra prediction directional mode. In this case, the intra prediction directional mode may include at least one of a DIMD mode, a TIMD mode, and an angle mode. In addition, the decoder may exclude the intra prediction directional mode from the GPM partition prediction candidate list for the area included in the low complexity group. In addition, the area included in the low complexity group may not be allowed to be encoded by using the intra MIP mode. In addition, the decoder may exclude the MIP mode from the GPM partition prediction candidate list for the area included in the low complexity group. For example, two areas of the current block to which the GPM mode is applied may be determined to have low complexity, and a syntax indicating such determination may be included in the bitstream. The decoder may parse the syntax indicating that two areas of the current block are determined to have low complexity from the bitstream, and construct the GPM partition prediction candidate list for two areas of the block only with a pre-specified mode. In this case, the pre-specified mode may be an intra prediction mode with little change in direction within the area. Specifically, the pre-specified mode may include one or more of a DC mode, a planar mode, a vertical mode, a horizontal mode, a diagonal mode, and an inverse diagonal mode. Through these embodiments, the number of candidates in the GPM partition prediction candidate list may be reduced, thereby reducing the complexity. Alternatively, when constructing the GPM partition prediction candidate list, if an intra prediction directional mode is used in which one of the two areas has normal characteristics and the other has complex characteristics, the encoder and decoder may reduce complexity by restricting the intra prediction directional mode of the area with normal characteristics to only use the planar mode (or DC).

The following is a description of a method for deriving a reconstructed GPM partition prediction candidate list by reconstructing the GPM partition prediction candidate list constructed by the above method in various ways.

In addition, when the difference between the index of the intra prediction directional mode corresponding to the first area of the first candidate and the index of the intra prediction directional mode corresponding to the first area of the second candidate in the GPM partition prediction candidate list is within a pre-specified value, and the difference between the index of the intra prediction directional mode corresponding to the second area of the first candidate and the index of the intra prediction directional mode corresponding to the second area of the second candidate is within a pre-specified value, the encoder and the decoder may exclude either the first candidate or the second candidate from the GPM partition prediction candidate list. The pre-specified value may be an integer greater than or equal to 1. Specifically, the pre-specified value may be 3. For example, the index of the intra prediction directional mode for the first area of the first candidate in the GPM partition candidate list may be 35, and the intra prediction directional mode for the second area may be 5. In this case, the index of the intra prediction directional mode for the first area of the second candidate in the GPM partition candidate list may be 34, and the intra prediction directional mode for the second area may be 6. The difference between the index of the intra prediction directional mode corresponding to the first area of the first candidate and the intra prediction directional mode corresponding to the first area of the second candidate is within 3, and the difference between the index of the intra prediction directional mode corresponding to the second area of the first candidate and the intra prediction directional mode corresponding to the second area of the second candidate is within 3. Therefore, the encoder and the decoder may exclude either the first candidate or the second candidate.

In the embodiments described above, when the difference between the index of the intra prediction directional mode corresponding to the first area of the first candidate and the index of the intra prediction directional mode corresponding to the first area of the second candidate in the GPM partition prediction candidate list is within a pre-specified value, or the difference between the index of the intra prediction directional mode corresponding to the second area of the first candidate and the index of the intra prediction directional mode corresponding to the second area of the second candidate is within a pre-specified value, the encoder and the decoder may exclude either the first candidate or the second candidate from the GPM partition prediction candidate list. In addition, in the above-described embodiment, the encoder and the decoder may exclude a candidate that is inserted late into the GPM candidate list among the first candidate and the second candidate. In another specific embodiment, the encoder and the decoder may exclude a candidate that requires more cost for reconstruction among the first candidate and the second candidate.

In another specific embodiment, the encoder and decoder may exclude a candidate from the GPM partition prediction candidate list based on the similarity between the intra prediction directional mode of the candidate and the partition shape of the GPM mode. The encoder and decoder may exclude a candidate from the GPM partition prediction candidate list if the similarity between the intra prediction directional mode of the candidate and the partition shape of the GPM mode is less than or equal to a pre-specified value. The similarity may be calculated based on the difference between the angle of the intra prediction directional mode and the value obtained by converting the direction of the partition reference line of the GPM mode into an angle.

FIG. 12 illustrates an angle of a partition reference line used in a GPM mode according to an embodiment of the disclosure.

The encoder and decoder may adjust the angle of the partition reference line used in the GPM mode based on the angle of the intra prediction directional mode used for intra prediction. This is because the granularity of the angle of the partition reference line used in the GPM mode is lower than the granularity of the angle of the intra prediction directional mode used for intra prediction. Specifically, when the angle of the partition reference line used in the GPM mode and the angle of the intra prediction directional mode used for intra prediction are different, the encoder and decoder may modify the angle of the partition reference line used in the GPM mode to the angle of the intra prediction directional mode used for intra prediction. In addition, the encoder and decoder may reconstruct the GPM partition prediction candidate list based on the angle of the partition reference line used in the modified GPM mode. In the embodiment of FIG. 12, the angle of the partition reference line of one candidate in the GPM partition prediction candidate list is 3, and the angle of the intra prediction directional mode used for intra prediction of the corresponding candidate is 37. In this case, the encoder and decoder change the angle of the partition reference line of the corresponding candidate to 3′.

In the template-based block prediction method, encoding efficiency may vary according to similarity between the template and the current block. Embodiments of increasing the efficiency of the template-based prediction method by increasing the similarity between the template and the current block will be described.

The encoder and the decoder may rearrange the GPM partition prediction candidate list generated through the embodiments described above in the encoder and decoder, based on at least one of the size of the current block, the width or height of the current block, the number of pixels of the current block, whether the current block is a luminance signal or a chrominance signal, the intra prediction directional mode of the neighboring block adjacent to the current block, the MPM list for the current block, the intra prediction directional mode derived from DIMD or TIMD, the GPM partition method for the neighboring block adjacent to the current block, whether the intra prediction directional mode of the GPM partition prediction candidate is the planar mode or DC mode, the cost value of each candidate in the GPM partition prediction candidate list. The encoder and decoder may designate the priority of the candidate whose difference between the index of the intra prediction directional mode of the neighboring block adjacent to the current block and the index of the intra prediction directional mode used for the candidate in the GPM partition prediction candidate list is within a pre-specified value, with a higher priority than the candidate whose absolute value of the difference between the index of the intra prediction directional mode of the neighboring block adjacent to the current block and the index of the intra prediction directional mode used for the candidate in the GPM partition prediction candidate list is equal to or greater than a pre-specified value. In this case, the pre-specified value may be an integer greater than or equal to 1. The pre-specified value may be 3. In another specific embodiment, the encoder and decoder may rearrange the GPM partition prediction candidate list so that the candidate whose intra prediction directional mode is the planar mode or the DC mode have a higher priority than the candidate whose intra prediction directional mode is neither the planar mode nor the DC mode among the candidates in the GPM partition prediction candidate list.

In another specific embodiment, the encoder and decoder may determine a weight used to calculate the cost of the candidate of the GPM partition prediction candidate list based on the difference between the index of the intra prediction directional mode of the adjacent neighboring block and the index of the intra prediction directional mode used for the candidate in the GPM partition prediction candidate list. Specifically, when the absolute value of the difference between the index of the intra prediction directional mode of the adjacent neighboring block and the index of the intra prediction directional mode used for the candidate in the GPM partition prediction candidate list is greater than a pre-specified value, the encoder and decoder may re-calculate the cost by multiplying the cost of the corresponding candidate calculated by SAD or MR-SAD by a weight greater than 1. The pre-specified value may be 0. In another specific embodiment, the pre-specified value may be an integer greater than 1. For example, the pre-specified value may be 3.

In another specific implementation, when the intra prediction directional mode for a candidate in the GPM partition prediction candidate list is the planar mode or DC mode, the encoder and decoder may recalculate the cost by multiplying the cost of the candidate calculated by SAD or MR-SAD by a weight greater than 1.

In addition, the weight value may be increased as the difference between the intra prediction directional mode of each candidate and the intra prediction directional mode of the neighboring block increases. In another specific embodiment, the weight value greater than 1 may be an integer greater than or equal to 2. For example, the weight value may be 2.

Alternatively, when the intra prediction directional mode for a candidate in the GPM partition prediction candidate list is neither the planar mode nor the DC mode, the encoder and decoder may recalculate the cost value by multiplying the cost value of the candidate calculated by SAD or MR-SAD by a weight greater than 1, such as 1.1 or 1.2.

When both areas of the current block encoded in the GPM mode are encoded in the intra prediction mode, the ISP mode may not be allowed in the corresponding area. That is, when the current block is encoded in the GPM mode, the decoder may infer the value of the syntax related to the ISP as O without parsing the syntax related to the ISP. In addition, when the current block is encoded in ISP mode, the decoder may infer the value of the syntax related to the GPM mode as 0 without parsing the syntax related to the GPM mode. In this case, 0 may mean that the corresponding mode is not applied to the current block.

When both areas of the current block encoded in the GPM mode are encoded in the intra prediction mode, only the reference pixel line closest to the current block may be used as the reference pixel line of the corresponding area. When the current block is encoded in the GPM mode, the decoder may infer the syntax related to the reference pixel line as 0 without parsing the syntax related to the reference pixel line. Alternatively, when the reference pixel line used for intra prediction of the current block is not zero, the decoder may infer the value of the syntax related to the GPM mode as 0 without parsing the syntax related to the GPM mode. In this case, 0 may mean that the corresponding mode is not applied to the current block.

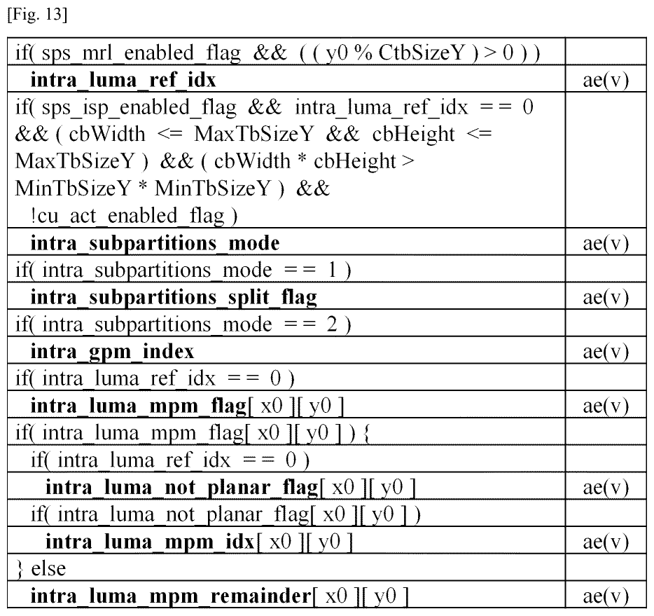

FIG. 13 illustrates a syntax structure of a method for signaling by integrating a GPM mode and an ISP mode according to an embodiment of the disclosure.

The GPM mode divides the current block into multiple areas, for example, two areas, and encodes the current block. Therefore, the GPM mode has characteristics similar to the ISP mode that divides vertically or horizontally. In addition, the selection ratio of the GPM mode is not large. Therefore, by integrating and signaling the GPM mode and the ISP mode, the encoding efficiency may be improved by reducing the number of bins to be encoded. Specifically, information on whether the current block is encoded in either the GPM mode or the ISP mode may be signaled by using one syntax. For example, the decoder may parse information on whether the current block is encoded in the GPM mode or the ISP mode. For convenience of description, information on whether the current block is encoded in the GPM mode or the ISP mode is referred to as the partition mode (partion_mode). When the value of the partition mode is 0, it may mean that the current block is not encoded in the GPM mode or the ISP mode. When the value of the partition mode is 1, the partition mode may mean that the current block is encoded in the ISP mode. In this case, the decoder may parse one or more syntaxes related to the ISP mode. When the value of the partition mode is 2, the partition mode may mean that the current block is encoded in the GPM mode. In this case, the decoder may parse one or more syntaxes related to the GPM mode. In this case, the decoder may parse intra_gpm_index, which is a syntax related to the GPM mode. The intra_gpm_index may be index information indicating the optimal candidate in the GPM partition prediction candidate list. The decoder may select an optimal GPM partition prediction candidate from the GPM partition prediction candidate list according to the index indicated by the intra_gpm_index. In this case, the partition mode may be signaled to a maximum of two bins. In addition, in order for the partition mode to be encoded or decoded with CABAC, different context models may be applied to the two bins signaling the partition mode. In another specific embodiment, the context model may be applied only to the first bin among the two bins signaling the partition mode, and the second bin may be encoded with by-pass.

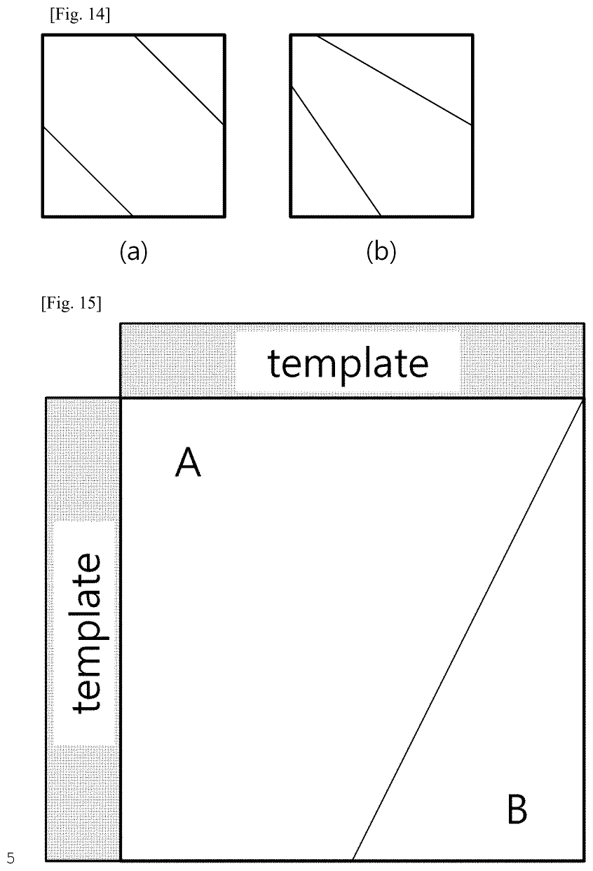

FIG. 14 illustrates a partition shape of a GPM mode that divides a current block into two or more areas according to an embodiment of the disclosure.

(a) of FIG. 14 illustrates a GPM mode that divides the current block into three areas based on the same angle. (b) of FIG. 14 illustrates a GPM mode that divides the current block into three areas based on the different angles. In addition, a GPM mode that divides the current block into four or more areas may be used. Each area divided in the current block may be encoded or decoded by using the intra prediction mode or the inter prediction mode, respectively. In another specific embodiment, at least one area among the areas divided in the current block may be encoded or decoded by using the intra prediction mode, and at least one area among the areas divided in the current block may be encoded or decoded by using the inter prediction mode. For example, when two of the three areas divided in the current block by the GPM mode are encoded by using the intra prediction mode, the remaining area may need to be encoded by using the inter prediction mode. In another specific embodiment, all areas divided in the current block by the GPM mode may be encoded by using the intra prediction mode. In this case, different intra prediction directional modes may be used for all the divided areas. In another specific embodiment, the same intra prediction directional mode may be used for all the divided areas. In another specific embodiment, the intra prediction mode for at least one area may be configured differently from the intra prediction directional modes for other areas, or a planar mode or a DC mode may be used.

FIG. 15 illustrates a partition shape of a current block to which a GPM mode is applied according to an embodiment of the disclosure.

In the GPM mode, the encoder and decoder may use template-based prediction for the area that is more adjacent to templates among areas divided in the current block, may not use template-based prediction for the area that is less adjacent templates. For example, in FIG. 15, the first area A is adjacent to the template, and the second area B is not adjacent to the template. Therefore, the encoder and the decoder may perform encoding and decoding by using template-based prediction for the first area A, and may not use template-based prediction for the second area B. In this embodiment, MPM-based intra prediction may be used for an area where template-based prediction is not used. In another specific embodiment, an area where template-based prediction is not used may be predicted by using one of planar mode, DC mode, or MIP mode. Specifically, the current block may be encoded in GPM mode, and both areas of the current block split in GPM mode may be encoded in intra prediction mode. In this case, the encoder and decoder may construct a template-based GPM partition prediction candidate list for one area. In this case, the decoder may decode the remaining areas by using one of MPM-based intra prediction directional mode, planar mode, DC mode, and MIP mode.

An embodiment is described in which both areas divided by the GPM mode are divided into intra prediction mode or inter prediction mode. In this case, when one area is encoded by using the intra prediction mode, whether PDPC is applied to the area may vary depending on how adjacent the corresponding area is to the reconstructed sample adjacent to the current block. Specifically, when a pre-specified number or more of boundary part samples are adjacent to the reconstructed neighboring block samples in one area, PDPC may be applied to the area. The pre-specified number may be an integer greater than or equal to 0. Specifically, the pre-specified number may be 4. As an embodiment, in FIG. 15, since area A is mostly adjacent to reconstructed samples adjacent to the current block, PDPC may be applied to area A. However, since area B has no or only one sample adjacent to reconstructed samples adjacent to the current block, PDPC may not be applied to area B.

The encoder and decoder may determine the strength of the deblocking filter to be used when reconstructing the current block based on whether one of the multiple areas divided by the GPM mode is encoded by using the intra prediction mode. When one of the two areas divided by the GPM mode is encoded by using the intra prediction mode, the encoder and decoder may configure the strength of the deblocking filtering (bs) to a pre-specified value when reconstructing the current block. For example, the pre-specified value may be 2. Accordingly, strong filtering may be applied to the boundary of the current block.

When any one of the two areas of the current block to which the GPM mode is applied is encoded in the inter prediction mode, the motion information of the corresponding area, for example, the motion vector, may be compensated by at least one of TM, DMVR, Multi-pass DMVR, and MMVD. In another specific embodiment, when one of the two areas of the current block to which the GPM mode is applied is encoded in the inter prediction mode, the motion information of the corresponding area, for example, the motion vector, may not be compensated. In this case, the decoder may infer a motion information compensation-related syntax for the area encoded in the inter prediction mode among the current areas divided by the GPM mode as a pre-specified value without parsing the syntax. The pre-specified value may be 0. The motion information compensation-related syntax may include at least one of information indicating whether to apply TM, information indicating whether to apply DMVR, and information indicating whether to apply MMVD. In another specific embodiment, when one of the two areas of the current block to which the GPM mode is applied is encoded in the inter prediction mode, and a pre-specified number or more of the boundary part samples are adjacent to the reconstructed neighboring block samples in the corresponding area, OBMC may be applied to the corresponding area. The pre-specified number may be an integer greater than or equal to 0. In this case, the pre-specified number may be 4. In another specific embodiment, when one of the two areas of the current block to which the GPM mode is applied is encoded in the inter prediction mode, and less than a pre-specified number of the boundary part samples are adjacent to the reconstructed neighboring block samples in the corresponding area, OBMC may not be applied to the corresponding area. In this case, the decoder may infer an OBMC-related syntax for the area encoded in the inter prediction mode among the current areas divided by the GPM mode as a pre-specified value without parsing the syntax. The pre-specified value may be 0. In addition, the pre-specified value may mean that the OBMC is not applied. In another specific embodiment, when one of the two areas of the current block to which the GPM mode is applied is encoded in the inter prediction mode, MHP mode may be applied to the corresponding area. In another specific embodiment, when one of the two areas of the current block to which the GPM mode is applied is encoded in the inter prediction mode, MHP mode may not be applied to the corresponding area. In this case, the decoder may infer an MHP mode-related syntax for the area encoded in the inter prediction mode among the current areas divided by the GPM mode as a pre-specified value without parsing the syntax. The pre-specified value may be 0. In addition, the pre-specified value may mean that the MHP is not applied.

The encoder may transform the residual signal to improve coding efficiency and quantize the transform coefficient value obtained through the transform. As described above, the transform unit may transform the residual signal to obtain the transform coefficient value. In this case, the residual signal of a specific block may be distributed to the entire area of the block. In this case, the encoder may apply a frequency domain transform to the residual signal to concentrate energy in the low-frequency area. Through this, the encoder may improve coding efficiency.

First, the encoder may obtain at least one residual block including the residual signal for the current block. The residual block may be either the current block or one of the blocks divided from the current block. For convenience of description, the residual block may be referred to as a residual array or a residual matrix including residual samples of the current block. In addition, the residual block may represent a block having the same size as the size of the transform unit or the transform block.

Next, the encoder may transform the residual block by using a transform kernel. The transform kernel used for transforming the residual block may be a transform kernel having a characteristic that allows separation of vertical transform and horizontal transform. In this case, the transform for the residual block may be performed separately as a vertical transform and a horizontal transform. For example, the encoder may perform vertical transform by applying a transform kernel in the vertical direction of the residual block. In addition, the encoder may perform horizontal transform by applying a transform kernel in the horizontal direction of the residual block. For convenience of description, the transform kernel may be used as a term referring to a set of parameters used for transforming a residual signal, such as a transform matrix, a transform array, a transform function, or a transform. In a specific embodiment, the transform kernel may be one selected from a plurality of kernels. In addition, transform kernels based on different transform types may be used for each of the vertical transform and the horizontal transform. That is, before performing the primary transform, a transform method for the vertical and horizontal directions may be derived by using at least one of the intra prediction mode of the current block, the encoding mode, the transform method parsed from the bitstream, and the size information of the current block. In addition, in order to reduce calculational complexity during the transforming process for large blocks, the high-frequency area may be processed as 0 leaving only the low-frequency area. This is referred to as high-frequency zeroing, and for this zeroing, the transform size may be configured during the actual primary transform. In the high-frequency zeroing process, the low-frequency area may be configured to an arbitrary fixed size. The horizontal size of the low-frequency area may be one of 4, 8, 16, and 32, and the vertical size may be one of 4, 8, 6, and 32.

The encoder may quantize the transform block transformed from the residual block by transferring the transform block to the quantization unit. In this case, the transform block may include a plurality of transform coefficients. Specifically, the transform block may be composed of a plurality of transform coefficients in a two-dimensional array. Like the residual block, the size of the transform block may be the same as either the current block or the block divided from the current block. The transform coefficient transferred to the quantization unit may be expressed as a quantized value.

In addition, the encoder may perform an additional transform before the transform coefficient is quantized. The above-described transform method may be referred to as primary transform, and the additional transform may be referred to as secondary transform. The secondary transform may be selectively applied to each residual block. In a specific embodiment, the encoder may perform the secondary transform for an area where it is difficult to concentrate energy in a low-frequency area with only the primary transform. For example, the secondary transform may be added for a block in which the residual value appears significantly in a direction other than the horizontal or vertical direction of the residual block. The residual value of an intra-predicted block may have a higher probability of changing in a direction other than the horizontal or vertical direction compared to the residual value of an inter-predicted block. Therefore, the encoder may additionally perform a secondary transform for the residual signal of the intra-predicted block. In addition, the encoder may omit the secondary transform for the residual signal of the inter-predicted block. High-frequency zeroing in the primary transform may also be performed in the secondary transform process.

In another specific embodiment, whether to perform a secondary transform may be determined based on the size of the current block or the residual block. In addition, different transform kernels may be used based on the size of the current block or the residual block. For example, an 8×8 secondary transform may be applied to a block whose shorter side length among the width or height is greater than or equal to the first pre-specified length. In addition, a 4×4 secondary transform may be applied to a block whose shorter side length among the width or height is greater than or equal to the second pre-specified length and less than the first pre-specified length. In this case, the first pre-specified length may be a value greater than the second pre-specified length. In addition, unlike the primary transform, the secondary transform may not be performed separately as a vertical transform and a horizontal transform. Such the secondary transform may be referred to as a low frequency non-separable transform (LFNST).

In addition, for a video signal of a specific area, the high-frequency band energy may not be reduced even if frequency transform is performed due to rapid brightness changes. Accordingly, the compression performance due to quantization may be degraded. In addition, when a transform is performed on an area where residual values rarely exist, the encoding time and decoding time may increase unnecessarily. Accordingly, transform for the residual signal of a specific area may be omitted. Whether transform is performed on the residual signal of a specific area may be determined by a syntax element related to the transform of the specific area. The syntax element related to transform may include transform skip information. The transform skip information may be a transform skip flag. When the transform skip information for a residual block indicates a transform skip, the transform for the residual block is not performed. In this case, the encoder may quantize the residual signal for which the transform is not performed.

The above-described transform-related syntax element may be information parsed from a video signal bitstream. The decoder may entropy-decode the bitstream to obtain transform-related syntax elements. In addition, the encoder may generate a video signal bitstream by entropy coding transform-related syntax elements.

The decoder may obtain encoding information necessary for decoding by parsing the bitstream. Information related to the transform process may include an index indicating the primary transform type, an index indicating the secondary transform type, and a quantized transform coefficient. The inverse transform unit may obtain a residual signal by inversely transforming the inverse quantized transform coefficient. First, the inverse transform unit may detect whether the inverse transform is performed for a specific area from the transform-related syntax elements of the specific area. When the transform-related syntax element for a specific transform block indicates a transform skip, the transform for the corresponding transform block may be omitted. In this case, both the primary inverse transform and the secondary inverse transform may be omitted for the transform block. In addition, the inverse quantized transform coefficient may be used as a residual signal. For example, the decoder may use the inverse quantized transform coefficient as the residual signal to reconstruct the current block. Alternatively, the secondary inverse transform may be performed and the primary inverse transform may be omitted. The secondary inverse transformed value may be used as a residual signal. The primary inverse transform described above represents the inverse transform for the primary transform, and may be referred to as the inverse primary transform. The secondary inverse transform represents the inverse transform for the secondary transform, and may be referred to as the inverse secondary transform or the inverse LFNST. In the disclosure, the primary (inverse) transform may be referred to as the first (inverse) transform, and the secondary (inverse) transform may be referred to as the second (inverse) transform.

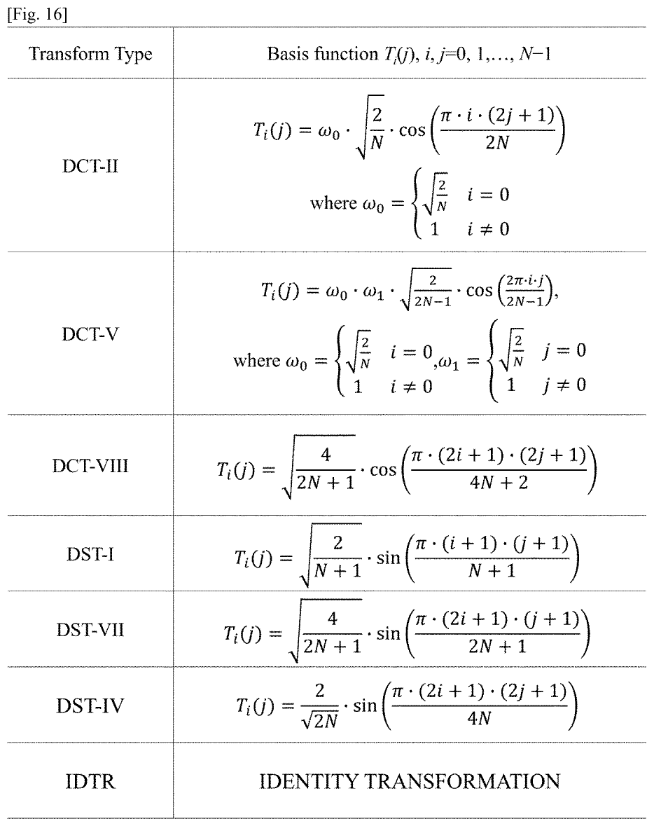

FIG. 16 illustrates types of transform kernels that may be used for video coding according to an embodiment of the disclosure.

Specifically, FIG. 16 illustrates the equations of DCT-II, DCT-V (discrete cosine transform type-V), DCT-VIII (discrete cosine transform type-VIII), DST-I (discrete sine transform type-I), and DST-VII kernels applied to MTS. DCT and DST may be expressed as functions of cosine and sine, respectively, and when the basis function of the transform kernel for the number of samples N is expressed as Ti(j), index i represents the index in the frequency domain, and index j represents the index within the basis function. That is, as i decreases, it represents a low-frequency basis function, and as i increases, it represents a high-frequency basis function. The basis function Ti(j) represents the jth element of the ith row when expressed as a two-dimensional matrix. All of the transform kernels illustrated in FIG. 16 have separable characteristics. Accordingly, the encoder may perform transform on the residual signal X in the horizontal and vertical directions, respectively. Specifically, when the residual signal block is X and the transform kernel matrix is T, the transform for the residual signal X may be expressed as TXT′. In this case, T′ is a transpose of the transform kernel matrix T. Since DCT and DST are in decimal form, not integer form, it is burdensome to implement them as they are in the hardware encoder and decoder. Therefore, the decimal form transform kernel must be approximated to an integer form transform kernel through scaling and rounding. The integer precision of the transform kernel may be determined as 8 bits or 10 bits. When the precision decreases, the encoding efficiency may decrease. Depending on the approximation, the orthonormal properties of DCT and DST may not be maintained, but the encoding efficiency loss due to this is not significant. Therefore, approximating the transform kernel to an integer form may be advantageous in terms of implementing the hardware encoder or decoder. Identity transform (IDTR) is a transform in which the result of the transform is the same as before the transform, and is referred to as an identity transform. In general, identity transform constructs a transform matrix by configuring 1 at the locations where rows and columns have the same value. However, identity transform uses an arbitrary fixed value other than 1 to increase or decrease the value of the input residual signal equally.

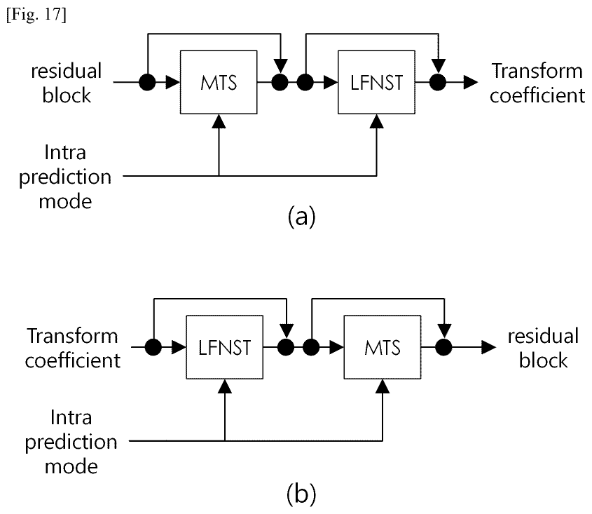

FIG. 17 illustrates a method of applying MTS and LFNST to an error signal of a current block to which a GPM mode is applied according to an embodiment of the disclosure. FIG. 17A illustrates the operation of an encoder, and FIG. 17B illustrates the operation of a decoder.

The GPM mode is applied, the current block is divided into two areas, and an intra prediction directional mode may be applied to the two areas. The decoder and the encoder may determine the MTS and LFNST transform methods based on one of the intra prediction directional modes corresponding to each of the two areas. In this case, the MTS and LFNST transform methods may be determined based on the angular mode among the two intra prediction directional modes corresponding to the two areas. Among the two intra prediction directional modes, the MTS and LFNST transform methods may be determined based on the angular mode, which is a non-directional mode such as a planar or DC mode. When both intra prediction directional modes corresponding to two areas are angular modes, the MTS and LFNST transform methods may be determined based on the intra prediction directional modes of the first area or the second area. In this case, the method of selecting the intra prediction directional modes used in the MTS and LFNST methods may be determined based on how small each area is adjacent to pixels adjacent to the current block. In this case, since the first area may have a high probability of being adjacent to an adjacent pixel of the current block, an error signal may be small. Therefore, the MTS and LFNST transform methods may be determined based on the intra prediction directional mode for the second area, which is likely to have a relatively large number of error signals.

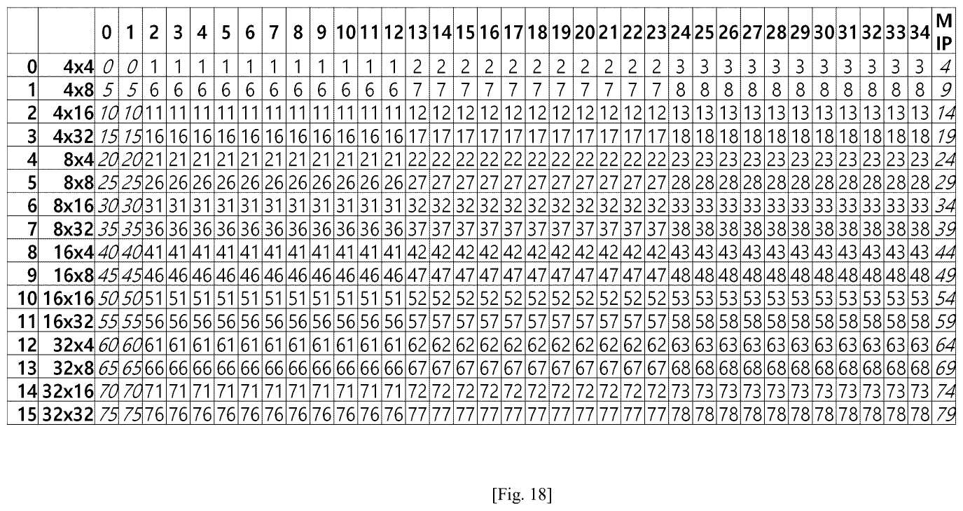

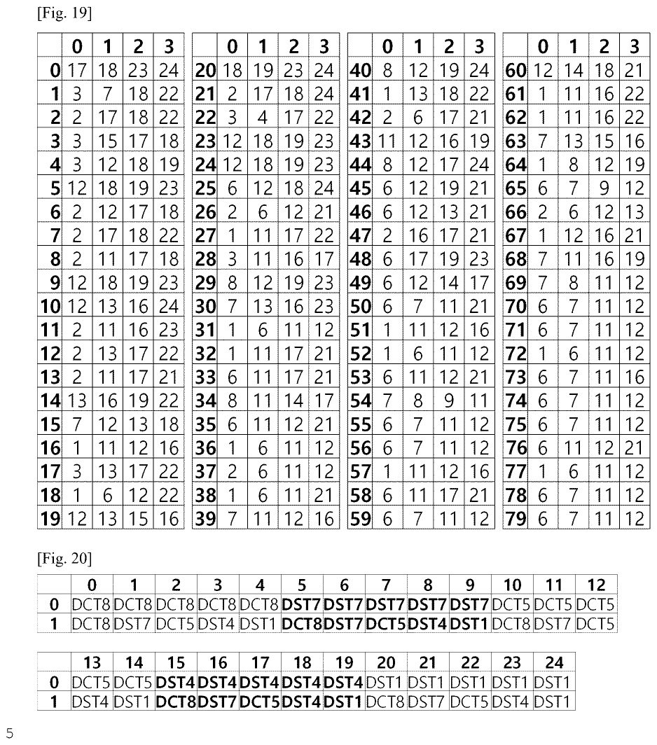

When the current block is predicted using the GPM mode, a method for selecting a multiple transform set (MTS) available for the current block by the encoder and decoder is described. FIG. 18 is a table illustrating the relationship between the value of the directional mode of the intra prediction mode corresponding to the area of the current block divided in the GPM mode and the index of the MTS set determined depending on the size of the current block according to an embodiment of the disclosure. The rows of the table correspond to the size of the current block, and the columns correspond to the index indicating the directional mode of the intra prediction mode. In this case, the directional mode includes MIP.
1) The encoder and decoder derive nSzIdx W and nSzIdxH values based on the size of the current block to map the width and height of the current block to a single variable as follows. The encoder and decoder configure the nSzIdx W to the minimum value among 3 and the value obtained by calculating the logarithm (log) of 2 to the width value of the current block, discarding the decimal place from the obtained value, and differencing 2. The encoder and decoder configure the nSzIdxH value by using the same method as the method of configuring the nSzIdx W based on the height value of the current block.
2) The intra directional mode (predMode) of the current block is derived, and when the TIMD mode is used to reconstruct the current block, the intra prediction modes extended from the original 67 to 131 are used. The encoder and decoder reduce the precision by reducing the number of intra directional modes (preMode) to 67 without the extended intra prediction mode.
3) The values of ucMode, nMdIdx, and isTrTransposed are derived as follows.
A. When the current block is encoded in MIP mode, the encoder and decoder configure the value of ucMode to 0, the value of nMdIdx to 35, and the value of isTrTransposed to a value derived from MIP.
B. When the current block is not encoded in MIP mode, the encoder and decoder derive the values of ucMode, nMdIdx, and isTrTransposed as follows.
i) The encoder and decoder configure the value of ucMode to the intra-directional mode of the current block.
ii) The encoder and decoder transform the value of predMode to the extended angle mode according to the width-height size ratio of the current block and configure the same to the value of predMode.
iii) The encoder and decoder clip the value of predMode to a value between 2 and 66.
iv) When the value of predMode is greater than 34, which is a diagonal mode, the encoder and decoder configure the value of isTrTransposed to 1, otherwise, the value of isTrTransposed to 0.
v) When the value of predMode is greater than 34, which is a diagonal mode, the encoder and decoder reconfigure a preMode value to the value obtained by differencing the preMode value to the value that adds 1 to the maximum value of preMode, 67. For example, if the predMode value is 35, the encoder and decoder may reconfigure the angle mode 35 to the angle mode 33(67+1−35). If the predMode value is 66, the video signal processing device may reconfigure the angle mode 66 to the angle mode 2(67+1−66). Through this, the range of the angle of the intra directional mode indicated by the preMode may be reduced to within 34, which is the diagonal mode. The number of combinations of the MTS sets determined by the value of the directional mode of the intra prediction mode corresponding to the area of the current block divided in the GPM mode and the size of the current block may be reduced by half.
4) The encoder and decoder derive the nSzIdx value based on the nSzIdx W, nSzIdxH, and isTrTransposed values. If the value of isTrTransposed is 1, the encoder and decoder multiply the value of nSzIdxH by 4 and add nSzIdx W to configure the value of nSzIdx. If the value of isTrTransposed is 0, the encoder and decoder multiply the value of nSzIdxW by 4 and add nSzIdxH to configure the value of nSzIdx.
5) The encoder and decoder derive nTrSet, which is an index of a set of available transform types by using a pre-specified table as illustrated in FIG. 18, through the values of nSzIdx, which indicates the size of the current block, and nMdIdx, which indicates the intra-directional mode of the current block. There may be 80 types of values that nTrSet may have. In an embodiment of FIG. 18, when the size of the current block is 4×8 and the index of the directional mode in the screen of the current block is 13, the value of nTrSet is 7.
6) The encoder and decoder obtain the transform type corresponding to the mts_idx value that is parsed from the transform type set corresponding to nTrSet. FIG. 19 is a table illustrating the relationship between the values of nTrSet and mts_idx according to an embodiment of the disclosure. In this case, the rows correspond to the index of nTrSet and the columns correspond to the index of mts_idx. The transform types in the vertical and horizontal directions are configured differently based on whether the value of predMode is greater than 34, which is a diagonal mode. In the embodiment of FIG. 19, if the value of nTrSet is 7 and the value of mts_idx is 3, among the indices 2, 17, 18, and 22 indicating the transform type, 22 is selected.

FIG. 20 is a table illustrating a relationship between an index indicating a transform type and a kernel used for transformation according to an embodiment of the disclosure. In this case, the columns correspond to the index of the transform type, and the rows correspond to the transform direction. In the embodiment of FIG. 20, if the value of the transform type is 22, the vertical transform kernel is DST1 and the horizontal transform kernel is DCT5. If the prediction directional mode within the screen of the current block is greater than 34, which is a diagonal mode, the vertical and horizontal transform types are swapped.
7) Finally, if the mts_idx value is 3 and both the width and height of the current block are less than or equal to 16, the vertical or horizontal transform type may be reconfigured to the IDT transform type through the following process.

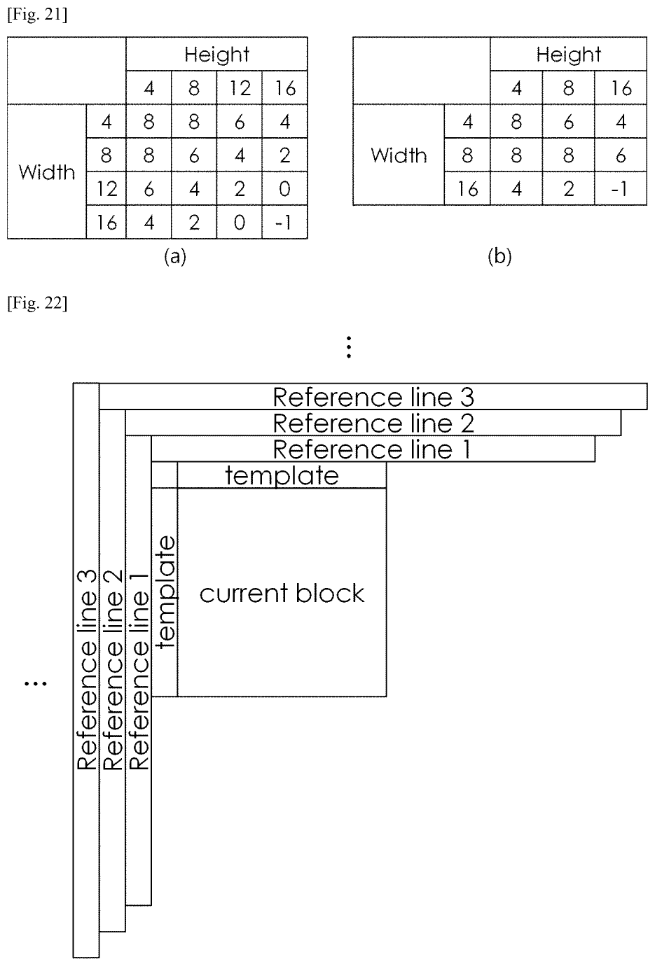

If the absolute difference between the prediction directional mode in the screen of the current block and the horizontal direction mode of 18 is less than a pre-specified value, the encoder and decoder reconfigure the vertical direction transform type to the IDT transform type. If the absolute difference between the prediction directional mode in the screen of the current block and the horizontal direction mode of 50 is less than a pre-specified value, the encoder and decoder reconfigure the horizontal direction transform type to the IDT transform type. In this case, it may be a pre-specified integer. In addition, the pre-specified value may be determined based on the horizontal or vertical size of the current block. FIG. 21 is a table illustrating a relationship between the horizontal and vertical sizes of the current block and a pre-specified value that serves as a criterion for reconfiguring the transform type according to an embodiment of the disclosure. FIG. 21A is a case where a pre-specified value is configured differently each time the horizontal or vertical size differs by 4. FIG. 21B is a case where a pre-specified value is configured differently each time the horizontal or vertical size differs by 2 times. In the embodiment of FIG. 21, when the size of the current block is 16×16, the encoder and decoder do not reconfigure the transform type to the IDT transform type, but maintain the existing transform type.

FIG. 22 illustrates a method of performing intra prediction by determining a reference pixel line based on a template according to an embodiment of the disclosure.

A template-based cost calculation method may be used to determine a reference pixel line used for intra prediction of the current block. The encoder and decoder may construct a template by using already reconstructed samples adjacent to the current block. Multiple reference pixel lines are located at pre-specified locations based on the current block. Specifically, the multiple reference pixel lines and templates may be as illustrated in FIG. 22. In addition, the multiple reference pixel lines may be located at one of 1, 3, 5,7, and 12 away from the boundary of the current block. The encoder and decoder generate prediction samples for the template locations based on the reference pixels. The encoder and decoder calculate a cost based on the difference between the generated prediction samples and the template. In this case, the encoder and decoder may use SAD or MR-SAD. The encoder may encode the current block by using the reference pixel line with the lowest cost. In this embodiment, the decoder performs intra prediction by using the reference pixel line with the lowest cost in relation to the template among the multiple reference pixel lines. In another specific embodiment, the encoder may construct a list of the multiple reference pixel lines sorted in ascending order based on cost, and include an index, in the non-stream, indicating a reference pixel line used for intra prediction in the list. In this embodiment, the decoder constructs a list of multiple reference pixels sorted by cost, and performs intra prediction by using a reference pixel line indicated by a signaled indicator in the constructed list. The intra prediction according to the embodiments described above is referred to as a template-based multiple reference line (TMRL) intra prediction method.

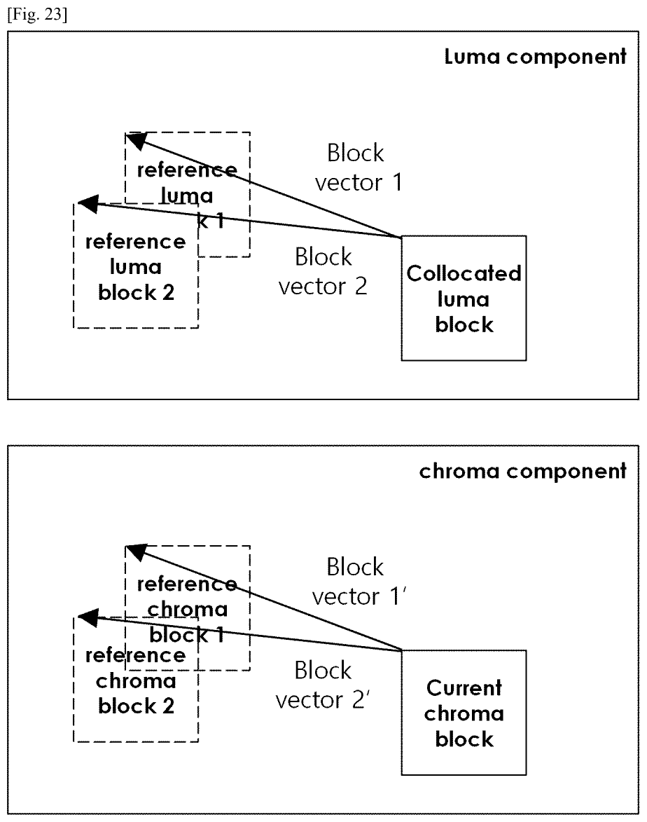

FIG. 23 illustrates a method of performing prediction by using a block vector of a block encoded in an IBC mode according to an embodiment of the disclosure.

The intra block copy (IBC) is a method of finding the block most similar to the current block among the reconstructed areas within the current picture and performing intra prediction by referring to the found block. In this case, the relationship between the reference block used for intra prediction and the current block is expressed as a vector. This vector is referred to as a block vector. The encoder includes information indicating the block vector in the bitstream. The decoder may parse information indicating the block vector from the bitstream to obtain a block vector for the current block. In the IBC, one or more reference blocks may be used. In this case, when the multiple reference blocks are used, information on the multiple block vectors may be included in the bitstream. In addition, the block vector used for the luminance block prediction may be used for the prediction of the chrominance block corresponding to the luminance block. FIG. 23 illustrates that a luminance block is predicted by using two reference blocks, and a chrominance block is predicted by using two block vectors used for luminance block prediction.

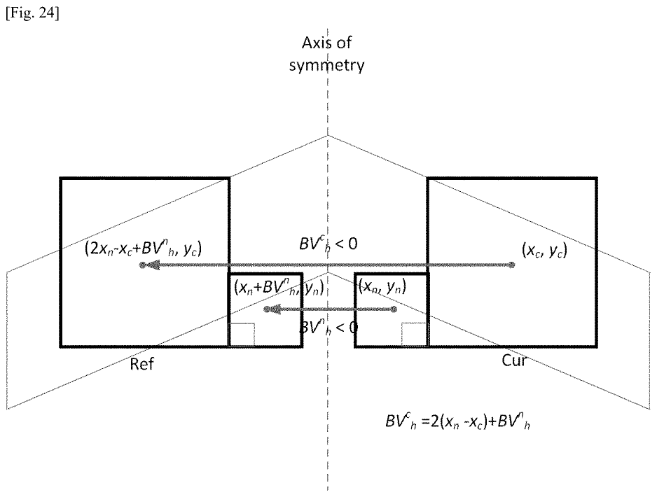

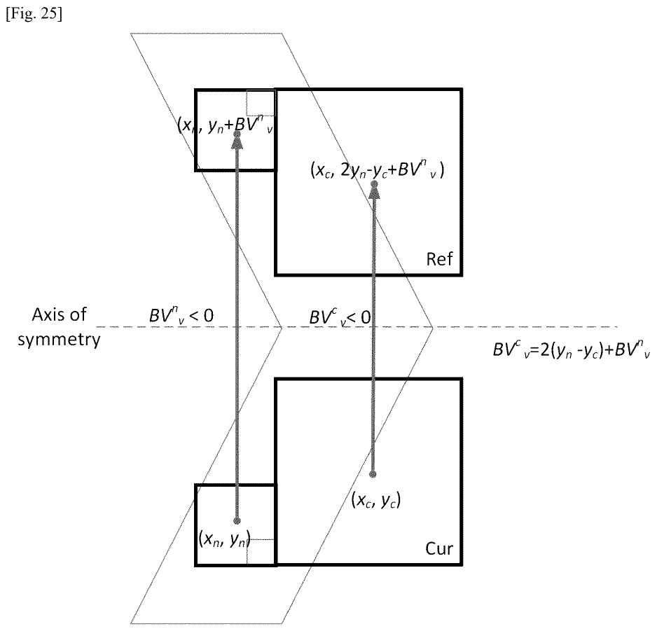

FIGS. 24 and 25 illustrate an RRIBC being performed according to an embodiment of the disclosure.

The reconstruction-reordered IBC (RRIBC) encoding mode may be used in an IBC block. The RRIBC flips a block based on the reference axis. In this case, a vertical flip or a horizontal flip may be performed. The encoder flips the current block vertically or horizontally to generate a flipped current block. The encoder finds a reference block most similar to the flipped current block from the already reconstructed reference area of the current picture. The encoder calculates a block vector, which is the distance to the reference block based on the upper left position of the current block. In this case, the block vector may be predicted through the block vector of the neighboring block adjacent to the current block. The prediction method for the block vector in the RRIBC mode will be described later. The encoder may include the difference value between the actual block vector and the predicted block vector in the bitstream. In addition, when the current block is encoded in the IBC mode, the encoder may include flip type information in the bitstream, such as whether to use a vertical flip, a horizontal flip, or not to use the RRIBC mode. After generating an error block, which is the difference between the flipped current block and the reference block, the encoder may transform and quantize the error block and then include the quantized transform coefficients in the bitstream.

The decoder may determine the RRIBC mode for the current block by parsing the flip type information when the current block is encoded in the IBC mode. The decoder may calculate the actual block vector by adding the predicted block vector value after parsing the difference value of the block vector. The decoder may generate an error block by parsing the quantized transform coefficients from the bitstream and then performing inverse quantization and inverse transform. The decoder may reconstruct the current block by adding the reference block indicated by the actual block vector and the error block. The decoder may flip the reconstructed current block according to the flip type information to generate the final reconstructed current block.

When the current block is in RRIBC mode, the encoder and decoder may predict the block vector prediction value (BVC) for the current block by using the following method. In FIGS. 24 and 25, (Xn, Yn) represents the center position of the neighboring block, and (Xc, Yc) represents the center position of the current block. BVn represents the block vector of the neighboring block, and BVC represents the block vector of the current block. As illustrated in FIG. 24, when RRIBC is performed in the horizontal direction of the current block, the BVC is 2*(Xn−Xc)+BVn. As illustrated in FIG. 25, when RRIBC is performed in the vertical direction of the current block, the BVC is 2*(Yn−Yc)+BVn. In this case, since the BVn and BVC use previously reconstructed block, only the negative sign of the block vector is possible.

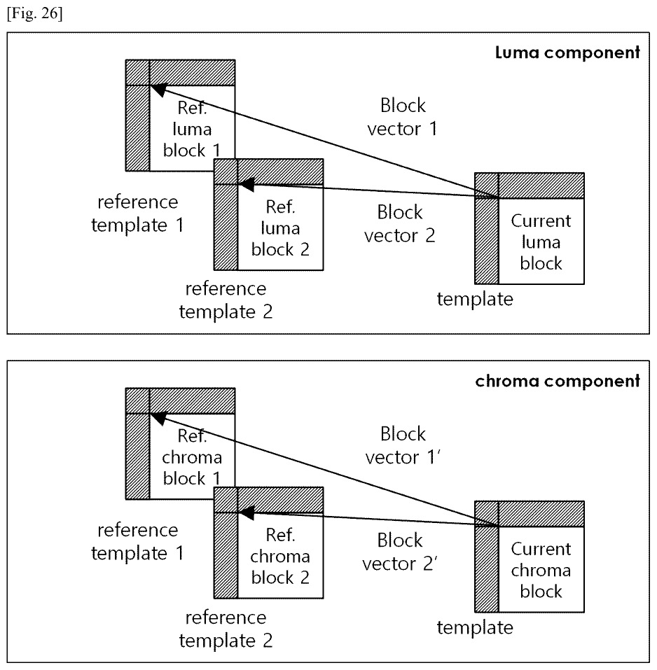

FIG. 26 illustrates an embodiment of a block vector of a block encoded in an intra TMP mode according to an embodiment of the disclosure.

In intra TMP (template matching prediction), the encoder and decoder construct a reference template by using pixel values of neighboring blocks adjacent to the current block. In this case, the encoder and decoder find an area most similar to the reference template in the already reconstructed area in the current picture, and determine a block including a similar area as a reference block. The encoder and decoder predict the current block based on the reference block. In this case, there may be multiple reference blocks. The prediction block for the luminance block is reconstructed by using the intra TMP, and the encoder and decoder may predict the chrominance block by using the block vector of the luminance block. In this case, the block vector used for prediction of the chrominance block may be the same as the block vector of the luminance block. Alternatively, depending on the difference in resolution between the luminance block and the chrominance block, the block vector of the luminance block may be changed and used as the block vector of the chrominance block. FIG. 26 illustrates that the luminance block is predicted based on two reference luminance blocks and two block vectors in the intra TMP. In addition, the encoder and decoder derive two block vectors for the current chrominance block based on the two block vectors used for the prediction of the luminance block. The encoder and decoder find two reference blocks by using the derived two block vectors, and predict the current chrominance block by using the two reference blocks.

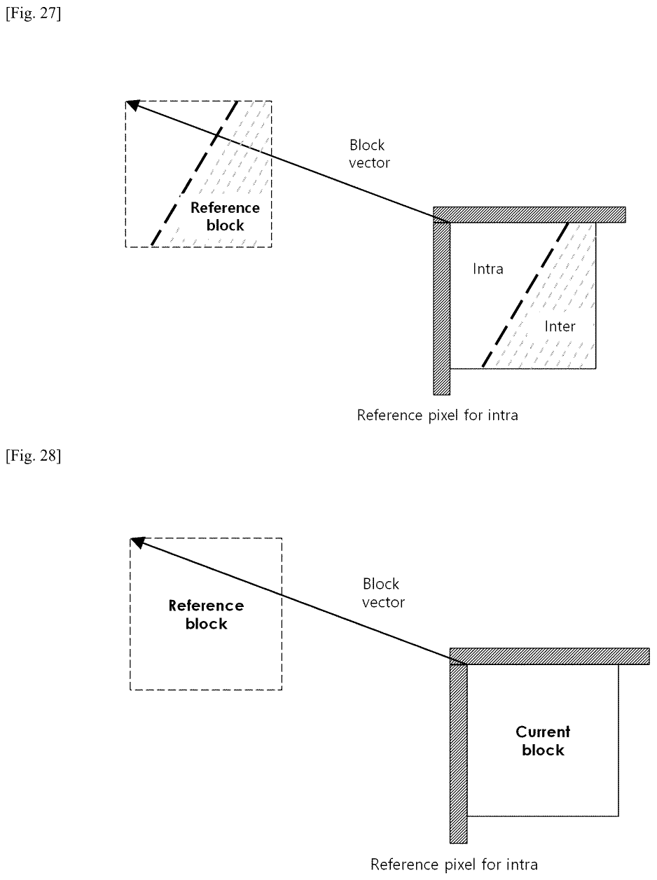

FIG. 27 illustrates that a current block is divided into two areas in a GPM mode and the divided areas are encoded in an IBC mode according to an embodiment of the disclosure.

The encoder and decoder may encode or decode the current block by using the IBC-GPM mode. In the IBC-GPM mode, the current block is divided by using the GPM mode, and the divided area may be encoded by using the intra prediction mode or the IBC prediction mode. The current block is divided into two areas, and one of the divided areas may be encoded by using the intra prediction mode, and the other area may be encoded by using the IBC prediction mode. In this case, the divided area may be encoded by using the intra TMP mode instead of the IBC prediction mode. FIG. 27 illustrates this. This may be referred to as the Intra TMP-GPM mode.

FIG. 28 illustrates that a current block is encoded in an IBC-CIIP mode according to an embodiment of the disclosure.

The encoder and decoder may predict the current block by using the weighted average between the intra predicted block and the IBC predicted block. This may be referred to as the IBC-CIIP mode. In this case, the intra TMP prediction mode, not the IBC predicted block, may be used for encoding or decoding, and this may be referred to as the IntraTMP-CIIP mode.

A method of performing deblocking filtering in various prediction methods described above may be a problem. First, general deblocking filtering is described, and how deblocking is performed for each prediction mode is described.

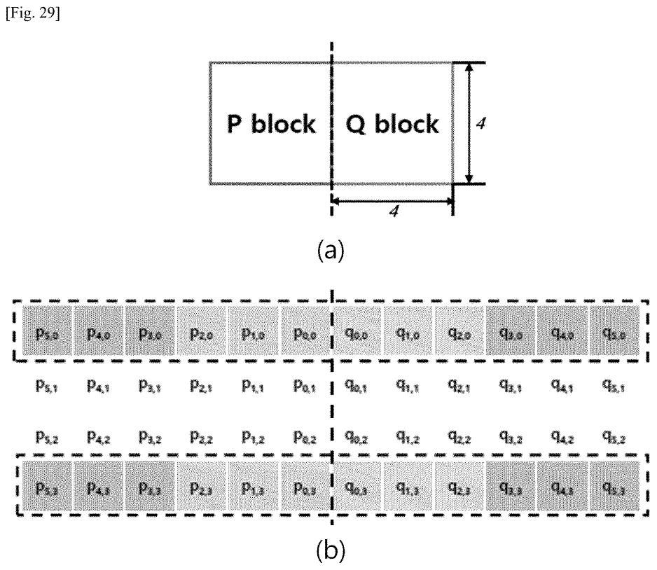

FIG. 29 illustrates an embodiment of a block boundary and samples around the block boundary in a deblocking filtering process according to an embodiment of the disclosure.

In (a) of FIG. 29, a dotted line between the P block and the Q block is a block boundary. The block boundary exists at arbitrarily determined size, every size of 4 in the case of (a) of FIG. 29. (b) of FIG. 29 illustrates a sample on which filtering is performed based on a block boundary. The encoder and decoder may perform deblocking filtering on the currently reconstructed block to mitigate the blocking phenomenon occurring at the block boundary. The deblocking filtering process may be performed after a process of determining a transform block boundary, a sub-block boundary, a length of a filter, a strength of filtering (bS), a filtering parameter, whether to perform filtering, and a type of filtering.

The neighboring block or the current block may be encoded in the IBC-CIIP mode or the IntraTMP-CIIP mode. In this case, a method for determining the strength of deblocking filtering applied to the boundary between the neighboring block and the current block is described. The encoder and the decoder may perform deblocking filtering with the same filtering strength as the filtering strength applied to the intra-predicted encoding mode on the boundary between the neighboring block and the current block. In another specific embodiment, the encoder and the decoder may perform deblocking filtering with a pre-specified filtering strength on the boundary between the neighboring block and the current block. The strength of the filtering may be distinguished as 0, 1, and 2, where 2 represents the strongest filtering strength, 1 represents the second strongest filtering strength, and 0 represents that no filtering is performed. In this case, the pre-specified strength may be 2. This is because the intra prediction is used in the IBC-CIIP mode and IntraTMP-CIIP mode. In another specific embodiment, the pre-specified strength may be 1. This is because the inter prediction is used in addition to the intra prediction in the IBC-CIIP mode and IntraTMP-CIIP mode.

In another specific embodiment, the encoder and decoder may perform deblocking filtering with a pre-specified filtering strength on the boundary between the neighboring block and the current block based on the difference in the block vector between the neighboring block and the current block. Specifically, when the difference in the block vector between the neighboring block and the current block is within a pre-specified value, the encoder and decoder may perform deblocking filtering with a pre-specified filtering strength on the boundary between the neighboring block and the current block. In this case, the pre-specified filtering strength may be 0. In addition, when the difference in the block vector between the neighboring block and the current block is greater than a pre-specified value, the encoder and decoder may perform deblocking filtering with a pre-specified filtering strength on the boundary between the neighboring block and the current block. In this case, the pre-specified filtering strength may be 1. In addition, the pre-specified value may be determined according to the resolution of the block vector. In addition, the pre-specified value may be an integer greater than or equal to 1. In addition, the resolution of the block vector may be one of ¼ pixel unit, ½ pixel unit, 1 pixel unit, and 4 pixel unit.

The neighboring block or the current block may be encoded in intra TMP mode. In this case, a method for determining the strength of deblocking filtering applied to the boundary between the neighboring block and the current block by the encoder and the decoder is described. The encoder and the decoder may perform deblocking filtering with the same filtering strength as the filtering strength applied to the inter-predicted encoding mode on the boundary between the neighboring block and the current block. In another specific embodiment, the encoder and the decoder may perform deblocking filtering with a pre-specified filtering strength on the boundary between the neighboring block and the current block. The pre-specified value may be 1.

In another specific embodiment, the encoder and decoder may perform deblocking filtering with a pre-specified filtering strength on the boundary between the neighboring block and the current block based on the difference in the block vector between the neighboring block and the current block. Specifically, when the difference in the block vector between the neighboring block and the current block is within a pre-specified value, the encoder and decoder may perform deblocking filtering with a pre-specified filtering strength on the boundary between the neighboring block and the current block. In this case, the pre-specified filtering strength may be 0. In addition, when the difference in the block vector between the neighboring block and the current block is greater than a pre-specified value, the encoder and decoder may perform deblocking filtering with a pre-specified filtering strength on the boundary between the neighboring block and the current block. In this case, the pre-specified filtering strength may be 1. In addition, the pre-specified value may be determined according to the resolution of the block vector. In addition, the pre-specified value may be an integer greater than or equal to 1. In addition, the resolution of the block vector may be one of ¼ pixel unit, ½ pixel unit, 1 pixel unit, and 4 pixel unit.

The neighboring block or the current block may be encoded in IBC-GPM or IntraTMP-GPM mode. In this case, a method for determining the strength of deblocking filtering applied to the boundary between the neighboring block and the current block by the encoder and the decoder is described. The encoder and the decoder may perform deblocking filtering with the same filtering strength as the filtering strength applied to the intra-predicted encoding mode on the boundary between the neighboring block and the current block. Specifically, the encoder and decoder may perform deblocking filtering with filtering strength 2 on the boundary between the neighboring blocks and the current block.

In another specific embodiment, the encoder and decoder may perform deblocking filtering with a pre-specified filtering strength on the boundary between the neighboring block and the current block based on the difference in the block vector between the neighboring block and the current block. Specifically, when the difference in the block vector between the neighboring block and the current block is within a pre-specified value, the encoder and decoder may perform deblocking filtering with a pre-specified filtering strength on the boundary between the neighboring block and the current block. In this case, the pre-specified filtering strength may be 0. In addition, when the difference in the block vector between the neighboring block and the current block is greater than a pre-specified value, the encoder and decoder may perform deblocking filtering with a pre-specified filtering strength on the boundary between the neighboring block and the current block. In this case, the pre-specified filtering strength may be 1. In addition, the pre-specified value may be determined according to the resolution of the block vector. In addition, the pre-specified value may be an integer greater than or equal to 1. In addition, the resolution of the block vector may be one of ¼ pixel unit, ½ pixel unit, 1 pixel unit, and 4 pixel unit.

The neighboring block or the current block may be encoded in the IBC-GPM or IntraTMP-GPM mode, and one of the areas divided by using the GPM mode may be encoded by using the intra prediction mode. In this case, the encoder and decoder may perform deblocking filtering with a pre-specified filtering strength on the boundary between the neighboring block and the current block based on the difference in block vectors between the neighboring block and the current block. The pre-specified filtering strength may be 2.

In another specific embodiment, the encoder and decoder may perform deblocking filtering with a pre-specified filtering strength on the boundary between the neighboring block and the current block based on the difference in the block vector between the neighboring block and the current block. Specifically, when the difference in the block vector between the neighboring block and the current block is within a pre-specified value, the encoder and decoder may perform deblocking filtering with a pre-specified filtering strength on the boundary between the neighboring block and the current block. In this case, the pre-specified filtering strength may be 0. In addition, when the difference in the block vector between the neighboring block and the current block is greater than a pre-specified value, the encoder and decoder may perform deblocking filtering with a pre-specified filtering strength on the boundary between the neighboring block and the current block. In this case, the pre-specified filtering strength may be 1. In addition, the pre-specified value may be determined according to the resolution of the block vector. In addition, the pre-specified value may be an integer greater than or equal to 1. In addition, the resolution of the block vector may be one of ¼ pixel unit, ½ pixel unit, 1 pixel unit, and 4 pixel unit.

The neighboring block or the current block may be encoded in RRIBC mode. In this case, a method for determining the strength of deblocking filtering applied to the boundary between the neighboring block and the current block by the encoder and the decoder is described. The encoder and decoder may perform deblocking filtering with a filtering strength of 0 on the boundary between the neighboring block and the current block based on the difference in the block vector between the neighboring block and the current block. The RRIBC mode is a mode performed on screen content, and is effective in images in which clear shapes such as letters and shapes appear repeatedly. Therefore, when the neighboring block or the current block is encoded in the RRIBC mode, the blocking phenomenon at the block boundary may not exist. In another specific embodiment, when the neighboring block or the current block is the IBC-GPM mode or the IBC-CIIP mode, and the IBC mode is the RRIBC mode, the encoder and decoder may perform deblocking filtering with a pre-specified filtering strength on the boundary between the neighboring block and the current block based on the difference in the block vector between the neighboring block and the current block. The pre-specified filtering strength may be 1.

The method of determining the strength of deblocking filtering through the embodiments described above may be applied equally not only to the boundary of a luminance block but also to the boundary of a chrominance block.

Whether the methods described in the disclosure are to be applied may be determined based on at least one of information about slice type information (e.g., whether it is an I slice, a P slice, or a B slice), whether it is a tile, whether it is a sub-picture, the size of the current block, the depth of the coding unit, whether the current block is a luminance block or a chrominance block, whether it is a reference frame or a non-reference frame, the reference order, and the temporal layer according to a layer, and the like. The information used to determine whether the methods described in the disclosure are to be applied may be pre-committed information between a decoder and an encoder. In addition, such information may be determined according to the profile and level. Such information may be expressed as variable values, and the bitstream may include information on variable values. That is, the decoder may determine whether the above-described methods are applied by parsing the information on the variable values included in the bitstream. For example, it may be determined whether the above-described methods are to be applied based on the horizontal length or vertical length of the coding unit. When the horizontal length or vertical length is 32 or more (e.g., 32, 64, 128, etc.), the above-described methods may be applied. In addition, when the horizontal length or vertical length is less than 32 (e.g., 2, 4, 8, 16), the above-described methods may be applied. In addition, when the horizontal length or vertical length is 4 or 8, the above-described methods may be applied.

The above methods described in the present specification may be performed by a processor in a decoder or an encoder. Furthermore, the encoder may generate a bitstream that is decoded by a video signal processing method. Furthermore, the bitstream generated by the encoder may be stored in a computer-readable non-transitory storage medium (recording medium).

The present specification has been described primarily from the perspective of a decoder, but may function equally in an encoder. The term “parsing” in the present specification has been described in terms of the process of obtaining information from a bitstream, but in terms of the encoder, may be interpreted as configuring the information in a bitstream. Thus, the term “parsing” is not limited to operations of the decoder, but may also be interpreted as the act of configuring a bitstream in the encoder. Furthermore, the bitstream may be configured to be stored in a computer-readable recording medium.

The above-described embodiments of the present invention may be implemented through various means. For example, embodiments of the present invention may be implemented by hardware, firmware, software, or a combination thereof.

For implementation by hardware, the method according to embodiments of the present invention may be implemented by one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, and the like.

In the case of implementation by firmware or software, the method according to embodiments of the present invention may be implemented in the form of a module, procedure, or function that performs the functions or operations described above. The software code may be stored in memory and driven by a processor. The memory may be located inside or outside the processor, and may exchange data with the processor by various means already known.

Some embodiments may also be implemented in the form of a recording medium including computer-executable instructions such as a program module that is executed by a computer. Computer-readable media may be any available media that may be accessed by a computer, and may include all volatile, nonvolatile, removable, and non-removable media. In addition, the computer-readable media may include both computer storage media and communication media. The computer storage media include all volatile, nonvolatile, removable, and non-removable media implemented in any method or technology for storing information such as computer-readable instructions, data structures, program modules, or other data. Typically, the communication media include computer-readable instructions, other data of modulated data signals such as data structures or program modules, or other transmission mechanisms, and include any information transfer media.

The above-mentioned description of the present invention is for illustrative purposes only, and it will be understood that those of ordinary skill in the art to which the present invention belongs may make changes to the present invention without altering the technical ideas or essential characteristics of the present invention and the invention may be easily modified in other specific forms. Therefore, the embodiments described above are illustrative and are not restricted in all aspects. For example, each component described as a single entity may be distributed and implemented, and likewise, components described as being distributed may also be implemented in an associated fashion.

The scope of the present invention is defined by the appended claims rather than the above detailed description, and all changes or modifications derived from the meaning and range of the appended claims and equivalents thereof are to be interpreted as being included within the scope of present invention.

1. A decoding device for decoding a video signal comprising
a processor,
wherein the processor is configured to:
divide a current block into multiple areas according to a reference line; and
perform prediction for each divided area, and
wherein at least one of the multiple areas is predicted through intra prediction.

2. The decoding device of claim 1,
wherein the processor is configured to generate candidates for each combination of the division shape and an intra prediction directional mode when generating a candidate list including candidates of intra prediction directional mode information used for prediction of at least one area predicted through the intra prediction.

3. The decoding device of claim 2,
wherein the processor is configured to exclude a candidate from the candidate list whose difference between the angle corresponding to the direction corresponding to the division shape and the angle indicated by the intra prediction directional mode is less than or equal to a pre-specified value.

4. The decoding device of claim 2,
wherein the processor is configured to exclude a candidate from the candidate list whose difference between the index of the intra prediction directional mode and the index of the intra prediction directional mode corresponding to the direction corresponding to the division shape is less than or equal to a pre-specified value.

5. The decoding device of claim 2,
wherein the processor is configured to configure the angle corresponding to the direction corresponding to the division shape of a first candidate to the angle indicated by the intra prediction directional mode when the angle corresponding to the direction corresponding to the division shape of the first candidate in the candidate list is different from the angle indicated by the intra prediction directional mode of the first candidate.

6. The decoding device of claim 2,
wherein the processor is configured to specify the priority of the first candidate as a higher priority than the second candidate when the difference between the index of the intra prediction directional mode of the neighboring block adjacent to the current block and the index of the intra prediction directional mode used for the first candidate in the candidate list is within a pre-specified value, and the difference between the index of the intra prediction directional mode of the neighboring block adjacent to the current block and the index of the intra prediction directional mode used for the second candidate in the candidate list is equal to or greater than the pre-specified value.

7. The decoding device of claim 2,
wherein the processor is configured to determine a weight to be used when calculating the cost of the candidate based on the difference between the index of the intra prediction directional mode of the neighboring block adjacent to the current block and the index of the intra prediction directional mode used for the candidate in the candidate list.

8. The decoding device of claim 7,
wherein the processor is configured to recalculate a cost by multiplying the cost of the corresponding candidate calculated by SAD or MR-SAD by a weight greater than 1 when the difference between the index of the intra prediction directional mode of the adjacent neighboring block and the index of the intra prediction directional mode used for the candidate is greater than a pre-specified value.

9. The decoding device of claim 2,
wherein the processor is configured to determine the candidates based on the shape of the current block when generating the candidate list.

10. The decoding device of claim 1,
wherein if the multiple areas include an area to be predicted through inter prediction, the processor is configured not to compensate a motion vector of the area to be predicted through the inter prediction.

11. An encoding device for encoding a video signal comprising a processor,
wherein the processor is configured to:
divide a current block into multiple areas according to a reference line; and
perform prediction for each divided area, and
wherein at least one of the multiple areas is predicted through intra prediction.

12. The encoding device of claim 11,
wherein the processor is configured to generate candidates for each combination of the division shape and an intra prediction directional mode when generating a candidate list including candidates of intra prediction directional mode information used for prediction of at least one area predicted through the intra prediction.

13. The encoding device of claim 12,
wherein the processor is configured to exclude a candidate from the candidate list whose difference between the angle corresponding to the direction corresponding to the division shape and the angle indicated by the intra prediction directional mode is less than or equal to a pre-specified value.

14. The encoding device of claim 12,
wherein the processor is configured to exclude a candidate from the candidate list whose difference between the index of the intra prediction directional mode and the index of the intra prediction directional mode corresponding to the direction corresponding to the division shape is less than or equal to a pre-specified value.

15. The encoding device of claim 12,
wherein the processor is configured to configure the angle corresponding to the direction corresponding to the division shape of a first candidate to the angle indicated by the intra prediction directional mode when the angle corresponding to the direction corresponding to the division shape of the first candidate in the candidate list is different from the angle indicated by the intra prediction directional mode of the first candidate.

16. The encoding device of claim 12,
wherein the processor is configured to specify the priority of the first candidate as a higher priority than the second candidate when the difference between the index of the intra prediction directional mode of the neighboring block adjacent to the current block and the index of the intra prediction directional mode used for the first candidate in the candidate list is within a pre-specified value, and the difference between the index of the intra prediction directional mode of the neighboring block adjacent to the current block and the index of the intra prediction directional mode used for the second candidate in the candidate list is equal to or greater than the pre-specified value.

17. The encoding device of claim 12,
wherein the processor is configured to determine a weight to be used when calculating the cost of the candidate based on the difference between the index of the intra prediction directional mode of the neighboring block adjacent to the current block and the index of the intra prediction directional mode used for the candidate in the candidate list.

18. The encoding device of claim 17,
wherein the processor is configured to recalculate a cost by multiplying the cost of the corresponding candidate calculated by SAD or MR-SAD by a weight greater than 1 when the difference between the index of the intra prediction directional mode of the adjacent neighboring block and the index of the intra prediction directional mode used for the candidate is greater than a pre-specified value.

19. The encoding device of claim 11,
wherein the processor is configured to determine the candidates based on the shape of the current block when generating the candidate list.

20. (canceled)

21. A computer-readable non-transitory storage medium storing a bitstream,
wherein the bitstream is decoded by a decoding method,
wherein the decoding method comprises:
dividing a current block into multiple areas according to a reference line; and
performing prediction for each divided area, and
wherein at least one of the multiple areas is predicted through intra prediction.
